(19) United States
(12) Patent Application Publication
(10) Pub. No.: US 2025/0071565 A1
(43) Pub. Date: Feb. 27, 2025

(54) END-TO-END SYSTEM FOR IMPROVING WIRELESS COVERAGE IN SHADOWED ZONES USING PASSIVE RF METASURFACES

(71) Applicant: Samsung Electronics Co., Ltd., Suwon-si (KR)

(72) Inventors: Aditya Dave, Plano, TX (US); Indranil Sinharoy, Richardson, TX (US); Hao Chen, Allen, TX (US); Daoud Burghal, San Jose, CA (US); Athul Prasad, Mountain View, CA (US); Jianzhong Zhang, Dallas, TX (US)

(21) Appl. No.: 18/791,282

(22) Filed: Jul. 31, 2024

Related U.S. Application Data
(60) Provisional application No. 63/534,716, filed on Aug. 25, 2023.

(51) Int. Cl. H04W 16/18; H01Q 15/00; H04W 24/08

(52) U.S. Cl. CPC H04W 16/18; H01Q 15/0086; H04W 24/08

(57) ABSTRACT

A method includes identifying a zone blocked from line of sight (LOS) of a gNB; receiving a 3D spatial map of a first area including the zone and a second area that surrounds the zone and that is within both a coverage area and the LOS of the gNB; determining whether the second area includes a mountable surface to which a passive RF reflective metasurface is attachable; and determining whether the metasurface, if attached to the mountable surface, generates a reflection path to the zone, based on a determination that the second area includes the mountable surface and based on estimated propagation paths from the gNB to the zone. The method includes determining whether to add a metasurface to the second area based on: a determination result whether the reflection path from the metasurface attached to the mountable surface to the zone includes reflected signals satisfying a threshold bandwidth condition.

### CROSS-REFERENCE TO RELATED APPLICATION(S) AND CLAIM OF PRIORITY

This application claims priority under 35 U.S.C. § 119(e) to U.S. Provisional Patent Application No. 63/534,716 filed on Aug. 25, 2023. The above-identified provisional patent application is hereby incorporated by reference in its entirety.

### TECHNICAL FIELD

This disclosure relates generally to wireless communication systems. More specifically, this disclosure relates to an end-to-end system for improving wireless coverage in shadowed zones using passive radio frequency (RF) metasurfaces.

### BACKGROUND

To support the high-capacity demands, high-band millimeter wave (mmWave) and sub-terahertz bands are used in next-generation 5G and 6G wireless communication, but the signal propagation mode becomes susceptible to scattering, absorption, and shadow fading losses causing zones of weak coverage and coverage blind spots. These problems are especially acerbated exactly where there is a growing demand for high bandwidth and high-speed wireless communication, such as in urban areas. Erecting or installing more and more base stations to improve the coverage in these areas is not a viable option, due to significant deployment costs involved.

### SUMMARY

This disclosure provides end-to-end system for improving wireless coverage in shadowed zones using passive RF metasurfaces.

In one embodiment, a method for improving wireless coverage in shadowed zones using passive RF metasurfaces from an end-to-end system] is provided. The method includes identifying a zone blocked from a line of sight (LOS) of a base station, based on data measured over time by a user equipment (UE) located proximately to the zone. The data includes downlink signal quality measurements. The method includes receiving a three-dimensional (3D) spatial map of a first area including the zone and a second area. The second area surrounds the zone and is within both a coverage area and the LOS of the base station. The method includes determining whether the second area includes a mountable surface to which a passive radio frequency reflective metasurface is attachable. The method includes determining whether the metasurface, if attached to the mountable surface, generates a reflection path to the zone, based on a determination that the second area includes the mountable surface and based on estimated propagation paths from the base station to the zone. The method includes determining whether to add a metasurface to the second area based on: a determination result of whether the second area includes the mountable surface; and a determination result whether the reflection path from the metasurface attached to the mountable surface to the zone includes reflected downlink signals that satisfy a threshold bandwidth condition.

In another embodiment, an electronic device for improving wireless coverage in shadowed zones using passive RF metasurfaces from an end-to-end system is provided. The electronic device includes a processor configured to identify a zone blocked from a line of sight (LOS) of a base station, based on data measured over time by a user equipment (UE) located proximately to the zone. The data includes downlink signal quality measurements. The processor is configured to receive a three-dimensional (3D) spatial map of a first area including the zone and a second area that surrounds the zone and that is within both a coverage area and the LOS of the base station. The processor is configured to determine whether the second area includes a mountable surface to which a passive radio frequency reflective metasurface is attachable. The processor is configured to determine whether the metasurface, if attached to the mountable surface, generates a reflection path to the zone, based on a determination that the second area includes the mountable surface and based on estimated propagation paths from the base station to the zone. The processor is configured to determine whether to add a metasurface to the second area based on: a determination result of whether the second area includes the mountable surface; and a determination result whether the reflection path from the metasurface attached to the mountable surface to the zone includes reflected downlink signals that satisfy a threshold bandwidth condition.

In yet another embodiment, a non-transitory computer readable medium comprising program code for improving wireless coverage in shadowed zones using passive RF metasurfaces from an end-to-end system is provided. The computer program includes computer readable program code that when executed causes at least one processor to identify a zone blocked from a line of sight (LOS) of a base station, based on data measured over time by a user equipment (UE) located proximately to the zone, the data including downlink signal quality measurements. The computer readable program code causes the processor to receive a three-dimensional (3D) spatial map of a first area including the zone and a second area that surrounds the zone and that is within both a coverage area and the LOS of the base station.

The computer readable program code causes the processor to determine whether the second area includes a mountable surface to which a passive radio frequency reflective metasurface is attachable. The computer readable program code causes the processor to determine whether the metasurface, if attached to the mountable surface, generates a reflection path to the zone, based on a determination that the second area includes the mountable surface and based on estimated propagation paths from the base station to the zone. The computer readable program code causes the processor to determine whether to add a metasurface to the second area based on: a determination result of whether the second area includes the mountable surface; and a determination result whether the reflection path from the metasurface attached to the mountable surface to the zone includes reflected downlink signals that satisfy a threshold bandwidth condition.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example gNodeB (gNB) according to this disclosure;

FIG. 3 illustrates an example electronic device in accordance with an embodiment of this disclosure;

FIG. 4 illustrates an example wireless network that includes a reconfigurable intelligent surface (RIS) and RIS controller that consume power from a power source in order to actively steer a beam impinging upon the RIS;

FIG. 5 illustrates different depictions of an example implementation of the end-to-end system for improving wireless coverage in shadowed zones using passive RF metasurfaces, according to embodiments of this disclosure;

FIG. 6 illustrates a block diagram of the end-to-end system for improving wireless coverage in shadowed zones using passive RF metasurfaces, according to embodiments of this disclosure;

FIG. 7 illustrates 3D map of an area of interest, according to embodiments of this disclosure;

FIG. 8 illustrates multiple coverage areas of a gNB and a shadow zone of poor coverage caused by an obstacle in the line-of-sight (LoS) path between the and a radio signal receiver located in the shadow zone;

FIG. 9 illustrates custom placement of a custom-designed passive RF metasurface to create strong non-LoS paths for illuminating weak coverage areas and coverage blind spot areas, according to embodiments of this disclosure;

FIG. 10 illustrates a method for determining whether to use passive RF metasurfaces or RISs, in accordance with an embodiment of this disclosure;

FIG. 11A illustrates a method for determining whether to use passive RF metasurfaces to solve a coverage problem based on the type of environment, according to embodiments of this disclosure;

FIG. 11B illustrates the first coverage area as a shadow zone having two LoS paths to two gNBs, and a second portion of a non-LoS path to a metasurface;

FIGS. 12A and 12B respectively illustrate a side view and a top view of two examples of unit cells of a passive RF metasurface, according to embodiments of this disclosure;

FIG. 13 illustrates a side view of two example unit cells that have different metal gratings, according to embodiments of this disclosure;

FIG. 14 illustrates a top-view of the two unit cells of FIG. 13 and a corresponding equivalent circuit, according to embodiments of this disclosure;

FIG. 15 illustrates an example of magnitude response and phase response for two unit-cells' geometries in FIGS. 13 and 14;

FIGS. 16, 17, and 18 illustrate multiple examples of a metasurface one or more reflected beams resulting from an incident beam at two different angles of incidence, according to embodiments of this disclosure;

FIG. 19 illustrates a method for training an encoder-decoder ML model and applying the trained encoder-decoder ML model to generate outputs based on an input query, according to embodiments of this disclosure;

FIG. 20 illustrates a method for training a simplified encoder-decoder ML model and applying the trained simplified encoder-decoder ML model to generate an output based on an input query, according to embodiments of this disclosure; and

FIG. 21 illustrates a method 2100 for improving wireless coverage in shadowed zones using passive RF metasurfaces from an end-to-end system in accordance with an embodiment of this disclosure.

### DETAILED DESCRIPTION

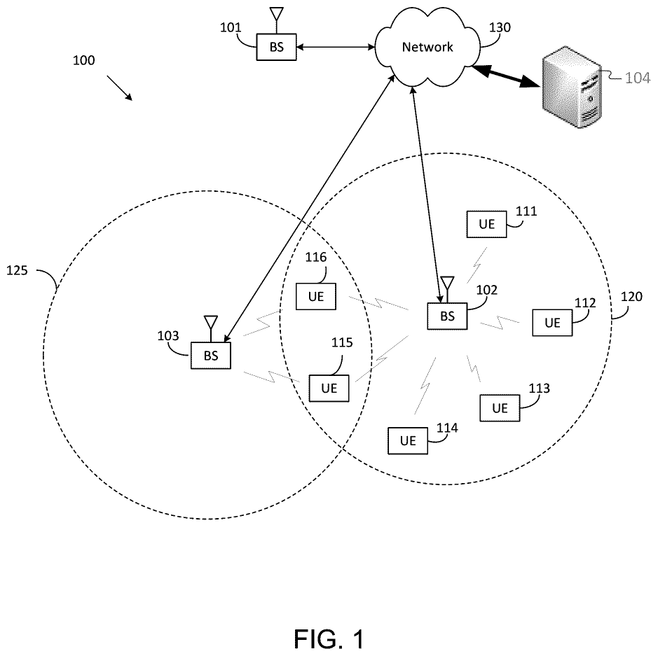

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

In urban areas, densely populated cities, and metropolises with urban canyons, the higher frequency signals for next generation 5G and future 6G wireless communication can be blocked or vitiated due to obstacles in the line-of-sight (LoS) path between the radio signal transmitters and receivers, and these obstacles create weak coverage zones and coverage blind spots. These weak coverage zones and coverage blind spots can disrupt wireless communication in several ways such as frequent call drops, connection loss, high latency, low data throughput, etc.

The continual increase in wireless communication devices fueled by the growth of Internet of Things (IoT) devices, high-definition video streaming services, immersive media applications such as AR/VR/XR, real-time holographic communications, etc. has pushed the demand for high-speed, high throughput, high bandwidth wireless cellular technologies. Next-generation wireless networks are increasingly adopting millimeter-wave (mmWave) 5G New Radio (NR) technology utilizing the frequency spectrum between 24 and 60 GHz to avail its high capacity and greater throughput. Other RF technologies such as WiGig (802.11 ad/ay) using 57-71 GHz, beyond 5G (B5G) using sub-terahertz (between 90 and 300 GHz), and forthcoming 6G technologies using frequencies between beyond 100 GHz are employing higher and higher frequency bands to harness greater bandwidth and throughput. However, higher-frequency radios are hitting fundamental coverage limitations due to their high directionality and propagation artifacts. The characteristics of the EM waves become adverse to radio propagation at such high frequencies. As the wavelength gets smaller and smaller compared to the size of buildings, vehicles, trees, etc. at higher 5G and 6G frequencies, the signals are absorbed, reflected, or scattered instead of being diffracting around objects restricting the condition of wireless communication to mainly line-of-sight (LoS). This problem is then exacerbated in urban areas, densely populated cities, and metropolises with urban canyons where the higher frequency signals could be blocked or vitiated due to obstacles in the LoS between the radio signal transmitters and receivers creating weak coverage zones and coverage blind spots.

Cellular networks typically include several base stations (BS) distributed around the region of coverage. These base stations (gNBs or eNodeBs) may be deployed on towers on land and building tops, street-light posts, etc. in the desired coverage region. Typically, the density of the serving base stations, integrated access backhaul (IAB), or active repeaters—collectively referred to as nodes in this disclosure—is increased to satiate the snowballing appetite for wireless communication capacity. However, installing base stations at every nook and corner of a city is not always viable physically (for example, due to space limitations). Moreover, evidentially, such solutions may be constrained by the aesthetics of the buildings and other structures in the city, the cost-effectiveness, power requirements, implementation complexity, and maintenance of high-density installation of these types of active nodes. Furthermore, coverage problems could be aggravated due to signal interference from neighboring cells in a cellular network characterized by densely packed active nodes and multiple cellular network providers.

As an alternative to installing additional base stations, Reconfigurable Intelligent Surfaces (RIS) are a recently emerging solution that requires less space and can be made visually appealing to maintain or even accent building aesthetics or city aesthetics. RIS, also called other names such as Intelligent Reflecting Surfaces (IRS), is essentially a 2D surface made of several (hundreds or thousands) of metamaterial elements called unit cells arranged in a regular or irregular 2D grid. Each unit cell in the RIS is comprised of layers of metals and electrical insulators or dielectrics along with one or more switches or other tunable components, a biasing layer, and a metallic ground layer. By controlling the biasing (namely controlling voltage) in each unit cell of the RIS, the cell can be switched ON or OFF and thus control how each cell alters (for example, by reflecting) the phase and amplitude of the incident electromagnetic wave. The superposition of emerging wavefronts from each unit cell of the RIS creates patterns of constructive and destructive interference such that the net power of the wireless signal is sent to a particular direction of interest, particularly to illuminate the area having weak signal coverage or a coverage blind spot.

The RIS does not boost the incident signal via amplification, but rather re-steers the signal to the direction of interest. Thus, although the RIS is active (for example, consuming electric energy and tunable by controlling voltage for biasing), and although the RIS exhibits dynamic beam-forming capabilities, operation of the RIS requires much less power compared to IABs and active repeaters. Also, because an RIS is a 2D surface, installation cost and complexity of the RIS are far less compared to that of BSs, IABs, or active repeaters. Furthermore, transparent and translucent materials may be used to fabricate RISs (also referred to as active RIS metasurfaces), making RISs suitable for use as windowpanes to redirect wireless signals inside buildings and rooms in urban canyons. Therefore, an RIS can be deployed in the high-frequency spectrum (e.g., mmWave and sub-Terahertz bands) to enhance SNR in weak wireless signal coverage areas and blind spots by overcoming non-line-of-sight propagation conditions in shadowed regions and enhancing outdoor-to-indoor communications in urban areas by controlling directivity of the signal scattered from the RIS, signal absorption, and polarization.

Yet another alternative approach for engineering the wireless channel to improve or augment (by adding indirect paths) the coverage is by utilizing passive RF metasurfaces, which is the primary focus of this disclosure. The passive RF metasurfaces, like RISs, are metamaterial surfaces that can alter the direction of propagation of incident electromagnetic waves to reflect, transmit, and/or diffract towards a desired direction that is not constrained by the usual geometrical laws of physics, such as Snell's law and Keller's cone. Similar to RISs, the passive RF metasurfaces do not incorporate signal amplifiers, but rather redirect the (impinging) energy in the desired directions via the constructive and destructive interference of the wavefronts emerging from the cells. The redirected energy propagates via reflected electromagnetic waves that have a phase, amplitude, polarization, or other such characteristics that have been modified or “filtered” by the unit cells of the passive RF metasurface. However, unlike RISs, RF metasurfaces are truly passive because the unit cell's electrical properties are not tuned dynamically, making such unit cells much simpler and cheaper to fabricate using regular 3D printing technology. In an embodiment of this disclosure, passive RF metasurfaces are designed and cheaply fabricated using simple 3D printing technology. These tailor-made RF metasurfaces are used to improve wireless coverage in weak coverage areas, coverage blind spots, and mitigate the effects of shadow fading in urban areas and high-rise buildings.

Embodiments of this disclosure overcomes the above-described problems in weak coverage zones and coverage blind spots. This disclosure provides an end-to-end system for discovering, analyzing, and solving wireless coverage problems by using tailor-made, custom-design, and custom-placement of passive radio frequency (RF) reflective metasurfaces to illuminate (for example, reflect signals into) weak coverage zones and coverage blind spots, thereby increasing the signal-to-noise ratio (SNR) in such zones and blind spots by creating strong non-line-of-sight (nLOS) signal paths. The end-to-end system according to embodiments of this disclosure determines whether a passive reflector is the solution to select (for example, as the better solution compared to an active reflector or new base station) for coverage enhancement based on considerations of cost, operational bandwidth, environment type, and time dependence of weak coverage. The end-to-end system according to embodiments of this disclosure uses a machine learning based (ML-based) technique to determine phase-weights for passive RF reflective metasurfaces to generate an arbitrary number of beams at desired directions. To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, this disclosure provides systems and methods for improving wireless coverage in shadowed zones using passive RF metasurfaces from an end-to-end system. The network 130 facilitates communication between various gNBs 102-103 in the wireless network 100. In this example, the network 130 facilitates communications between a server 104 and various gNBs 101-103. In this example, any of the UEs 111-116 can communicate via one or more gNBs 102-103 to interact with (for example, transmit information securely and efficiently to) another device, such as at least one server (such as the server 104) or other computing device(s), over the network 130. For example, the network 130 can communicate IP packets, frame relay frames, Asynchronous Transfer Mode (ATM) cells, or other information between network addresses. The network 130 includes one or more local area networks (LANs), metropolitan area networks (MANs), wide area networks (WANs), all or a portion of a global network such as the Internet, or any other communication system or systems at one or more locations. Each server 104 could, for example, include one or more processing devices, one or more memories storing instructions and data, and one or more network interfaces facilitating communication over the network 130.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

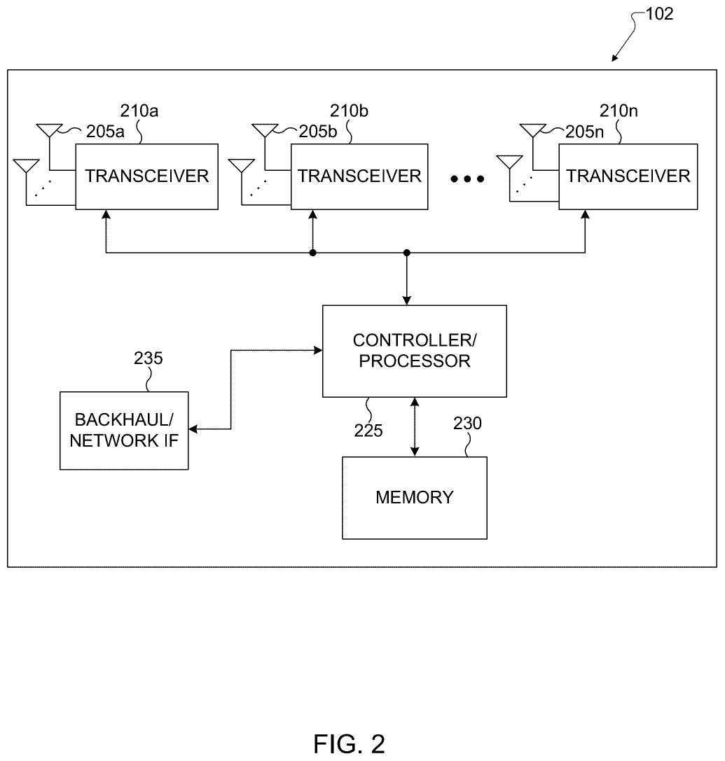

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

As described in more detail below, the gNB 102 implements methods for improving wireless coverage in shadowed zones using passive RF metasurfaces from an end-to-end system.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

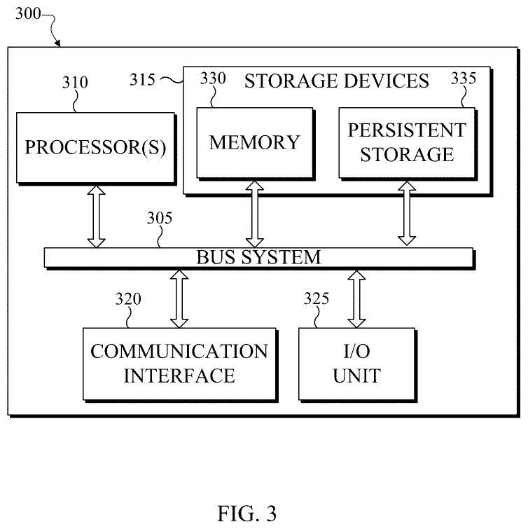

FIG. 3 illustrates an example electronic device in accordance with an embodiment of this disclosure. The electronic device can represent a computer, such as a server. In particular, FIG. 3 illustrates an example server 300, and the server 300 could represent the server 104 in FIG. 1. The server 300 can represent one or more encoders, decoders, local servers, remote servers, clustered computers, and components that act as a single pool of seamless resources, a cloud-based server, and the like. The server 300 can be accessed by the gNBs 101, 102, and/or 103 of FIG. 1, one or more of the UEs 111-116 of FIG. 1, or another server.

The server 300 can represent one or more local servers, one or more compression servers, or one or more encoding servers, such as an encoder. In certain embodiments, the encoder can perform decoding. As shown in FIG. 3, the server 300 includes a bus system 305 that supports communication between at least one processing device (such as a processor 310), at least one storage device 315, at least one communications interface 320, and at least one input/output (I/O) unit 325.

The processor 310 executes instructions that can be stored in a memory 330. The processor 310 can include any suitable number(s) and type(s) of processors or other devices in any suitable arrangement. Example types of processors 310 include microprocessors, microcontrollers, digital signal processors, field programmable gate arrays, application specific integrated circuits, and discrete circuitry. In certain embodiments, the processor 310 executes methods for improving wireless coverage in shadowed zones using passive RF metasurfaces from an end-to-end system.

The memory 330 and a persistent storage 335 are examples of storage devices 315 that represent any structure(s) capable of storing and facilitating retrieval of information (such as data, program code, or other suitable information on a temporary or permanent basis). The memory 330 can represent a random-access memory or any other suitable volatile or non-volatile storage device(s). For example, the instructions stored in the memory 330 can include instructions for methods for improving wireless coverage in shadowed zones using passive RF metasurfaces from an end-to-end system. The persistent storage 335 can contain one or more components or devices supporting longer-term storage of data, such as a read only memory, hard drive, Flash memory, or optical disc.

The communications interface 320 supports communications with other systems or devices. For example, the communications interface 320 could include a network interface card or a wireless transceiver facilitating communications over the network 130 of FIG. 1. The communications interface 320 can support communications through any suitable physical or wireless communication link(s). For example, the communications interface 320 can transmit a bitstream containing a 3D point cloud to another device such as one of the client devices 106-116.

The I/O unit 325 allows for input and output of data. For example, the I/O unit 325 can provide a connection for user input through a keyboard, mouse, keypad, touchscreen, or other suitable input device. The I/O unit 325 can also send output to a display, printer, or other suitable output device. Note, however, that the I/O unit 325 can be omitted, such as when I/O interactions with the server 300 occur via a network connection.

Note that while FIG. 3 is described as representing the server 104 of FIG. 1, the same or similar structure could be used in one or more of the various client devices 106-116. For example, a desktop computer or a laptop computer could have the same or similar structure as that shown in FIG. 3.

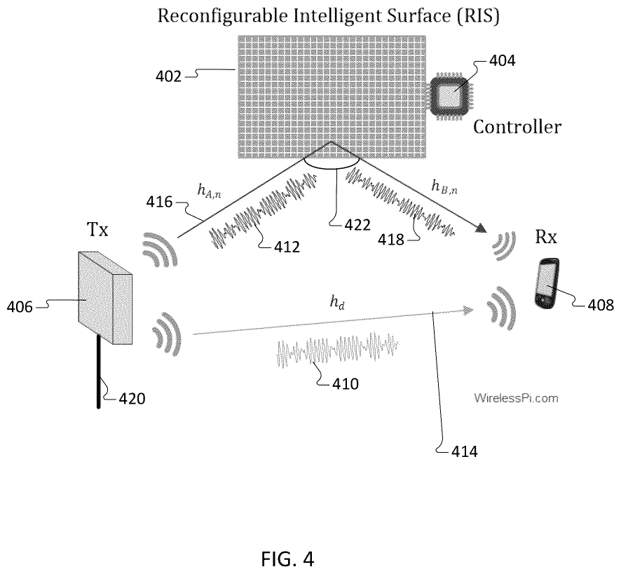

FIG. 4 illustrates an example wireless network 400 that includes a reconfigurable intelligent surface (RIS) 402 and RIS controller 404 that consume power from a power source in order to actively steer a beam impinging upon the RIS. The wireless network 400 includes a transmitter 406 and a receiver 408. The transmitter 406 transmits multiple beams 410 and 412 to the receiver 408 using beam steering to transmit the first beam 410 along a LoS path 414 and transmits the second beam 412 along a non-LoS path 416. The transmitter 406 includes a backhaul interface 420 for communicating with a backhaul network. The second beam 412 impinges upon the RIS 402 that reflects and redirects at least some energy of the impinging beam as a reflected beam 418 in specified direction (such as a specified change of angle 422) that the RIS controller 404 specified. That is, the RIS controller 404 applies a bias voltage to one or more unit cells that form a set (or multiple sets of unit cells) of the RIS 402 that causes the RIS 402 to direct the reflected beam 418 into the specified direction related to the bias voltage applied, by redirecting the impinging second beam 412. In the example shown, the unit cells of the RIS 402 are arranged in an array that includes columns and rows, and the RIS controller 404 is able to control different reflection areas and to tune the properties of the unit cells of the RIS, such as reflection properties for controlling different phase angles.

The length of the LoS path 414 can be the separation distance from the transmitter 406 to the receiver 408. The length of the non-LoS path 416 can be greater than the length of the LoS path 414. Particularly, length of the non-LoS path 416 can be a combination of the separation distance from the transmitter 406 to the RIS 402 that the first beam 410 propagates, plus the separate distance from the RIS 402 to the receiver 408 that the reflected beam 418 propagates.

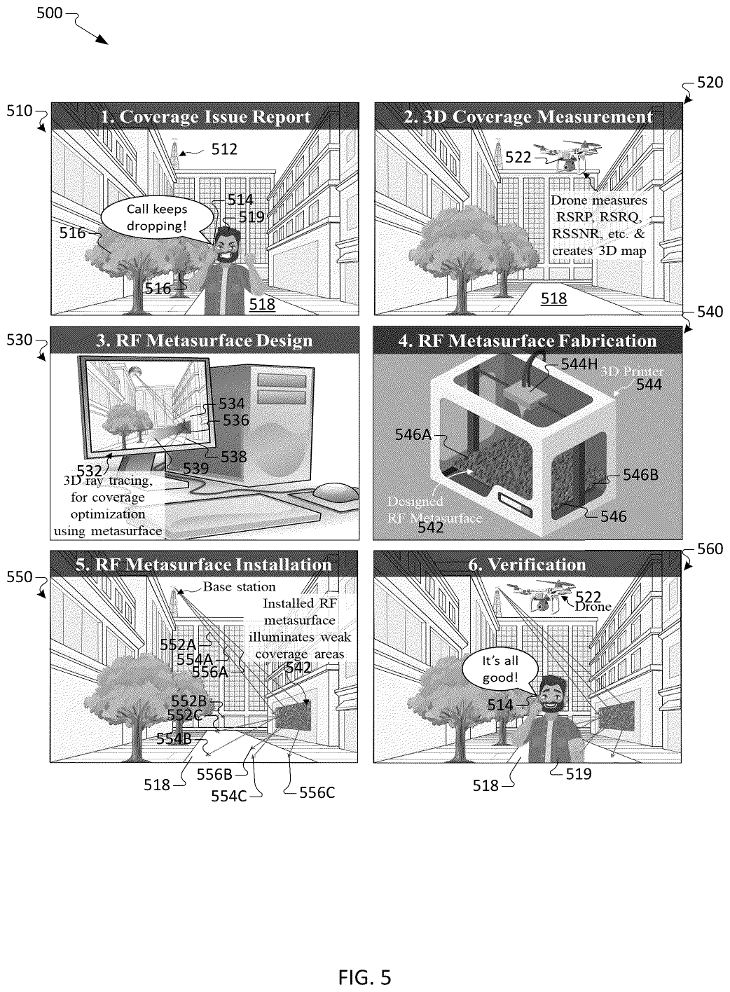

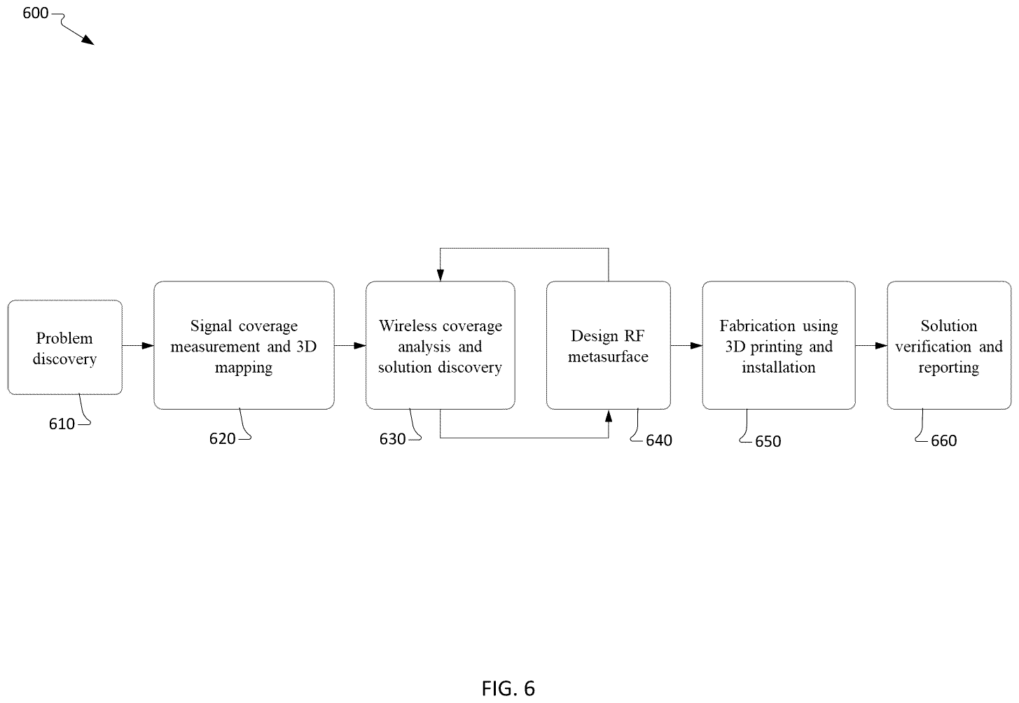

FIGS. 5 and 6 illustrate an end-to-end system for improving wireless coverage in shadowed zones using passive RF metasurfaces, according to embodiments of this disclosure. More particularly, FIG. 5 illustrates different depictions of an example implementation of the end-to-end system 500 for improving wireless coverage in shadowed zones using passive RF metasurfaces, according to embodiments of this disclosure. FIG. 6 illustrates a block diagram of the end-to-end system 600 for improving wireless coverage in shadowed zones using passive RF metasurfaces, according to embodiments of this disclosure. The end-to-end system 500, 600 can be a pipeline for wireless coverage problem discovery, signal coverage measurement, environment mapping, RF metasurface design, fabrication, installation, and finally solution verification. The end-to-end system 500, 600 can be used as a tools that a service provider uses to provide services of problem discovery through solution verification and reporting. More particularly, the end-to-end system 500, 600 could be a method performed by a processor of an electronic device, such as the processor 310 of the server 300 of FIG. 3.

As shown in FIG. 5, the end-to-end system 500 includes problem discovery (block 510), 3D signal coverage measurement (block 520) that includes measuring signal coverage and 3D mapping, RF metasurface design (block 530) that follows wireless coverage analysis and solution discovery, RF metasurface fabrication (block 540), RF metasurface installation (block 550), and solution verification (block 560). The different parts of the end-to-end system 500 are arranged in chronological order from coverage issue discovery to verification of improvement of the coverage using RF metasurfaces.

As shown in FIG. 6, the end-to-end system 600 includes problem discovery (block 610), 3D signal coverage measurement and 3D mapping (block 620), wireless coverage analysis and solution discovery (block 630), RF metasurface design (block 640), RF metasurface fabrication and installation (block 650), and solution verification and reporting (block 660). Although the different parts of the end-to-end system 600 are arranged in chronological order from coverage issue discovery to verification of improvement of the coverage using RF metasurfaces, various steps in FIG. 6 could overlap, occur in parallel, occur in a different order, or occur any number of times.

Together, additional details of FIGS. 5 and 6 are described further below, and will be described as being performed by the server 300. At blocks 510 and 610, the server 300 performs problem discovery, which includes accumulating user data over time. In an example scenario, mobile network operators or cellular network providers and their customers may discover the wireless coverage issues such as spotty connections due to weak coverage or coverage blind spots. For example as shown in block 510, signals transmitted between a gNB 512 and UE 514 may be blocked or vitiated due to obstacles 516 in the LoS between the radio signal transmitters and receivers creating a weak coverage zone 518 and coverage blind spots, such that a user 519 of the UE 514 located in the zone 518 may state “Calls keep dropping!” or otherwise report a coverage problem to a network operator. That is, the zone 518 is within the coverage area of gNB the 512 and is experiencing coverage problems. These problems (for example, coverage issues or reports from customers) may then be logged into the system (for example, the server 300 or a system of multiple servers) for further analysis and solution discovery. The coverage issue reports may include information such as problem occurrence instances, time, and geographical coordinate information. The time information could be used to analyze the dynamics of the coverage problem. Some or all parameters in these reports may be auto-generated by a network provider based on instances of tracked connection disruptions or call drops, ping-pong handovers, and signal strengths reported by UEs to the serving base stations. In some embodiments, a priority score is assigned to the issue reports, and the issue reports are analyzed and served (for example, addressed or solved) based on the priority score.

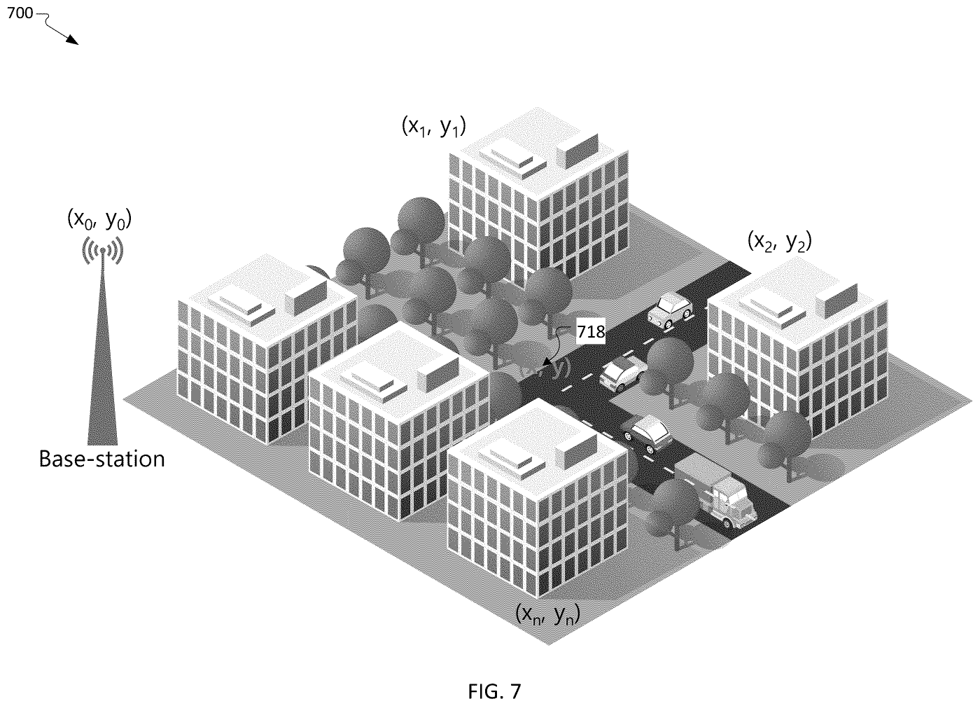

At blocks 520 and 620, the server 300 performs 3D signal coverage measurement and 3D mapping. The server 300 can perform 3D mapping of an area-of-interest to generate a 3D map, such as the 3D map 700 of FIG. 7. The server 300 can create the 3D map as a 3D layout of an area-of-interest, for example, using LiDAR or other mapping technology. In the example shown at block 520, the server 300 can connect to and receive mapping data (for example, data from LiDAR or other mapping technology) from on a drone 522, an uncrewed ariel vehicle (UAV), land rover robot, or a combination of such robots deployed to the area of interest (for example, location affected with poor coverage) to diagnose the coverage issue. Historically, the UAV referred to an “unmanned aerial vehicle.” The server 300 obtains downlink signal quality measurements measured within the area-of-interest at various 3D spatial locations mapped into the 3D map.

As an example, the drone 522 can include sensors configured to generate the user data, including downlink signal quality measurements such as reference signal measurements. The drone 522 various sensors, and can include one or more GPS sensors for navigating to and from the area-of-interest, LiDAR sensors and one or more image sensors (i.e., cameras) for generating the 3D layout in color, and motion sensors (such as an inertial measurement unit (IMU)) for determining 3D spatial locations within the area-of-interest. The drone 522 can generate and send a 3D map to the server 300, for example, via a connection to an I/O unit or to a communication interface. The drone 522 includes one or more types of RF scanners, Universal Software Radio Peripheral (USRP), or UE devices that can measure one or more types of signal strengths. For example, the drone 522 can be a UE or can include the same components as the UE 116 of FIG. 1, and is able to communicate with the gNBs 101-103 to generate downlink signal quality measurements including at least one of: Reference Signal Received Power (RSRP); Reference Signal Strength Indicator (RSSI); Reference Signal Signal-to-Noise Ratio (RSSNR); or Signal to Interference plus Noise Ratio (SINR). In some embodiments of this disclosure, the user data includes other parameters such as cell signal quality (CSQ), serving physical cell identity (PCI), channel quality indicator (CQI), E-UTRA absolute radio frequency channel number (EARFCN), and signal strength and parameters from neighboring cells can also be measured.

The RSRP is a measure of the average power of the useful signal received from a single cell-specific reference signal resource element theoretically ranging between −140 dBm (minimum) and −44 dBm (maximum). Typically, in an LTE network, this RSRP value ranges between −75 dBm near a base station (for example, in best case scenario) to −120 dBm at the edge of the cellular network coverage (for example, in a worst case scenario).

The RSSI is a measure of the total wideband signal received power observed containing contributions from noise, serving cell power, and interference power from the neighboring cells in the measurement bandwidth over N resource blocks. While the RSRP provides information about the signal strength, the RSSI helps in determining the extent of interference and noise.

The RSRQ is formulated as a ratio of RSRP to

$$\frac{RSSI}{N}$$

where N represents the number or physical resource blocks over which the RSSI is measured, and is typically equal to the system bandwidth. The RSRQ, measured over the same bandwidth, provides a better estimate of the channel quality and whole bandwidth. The RSRQ ranges between −3 dB to −19.5 dB. The RSRQ, computed from the RSRP and RSSI, quantifies the quality of the coverage. These measurements are typically used both for network design and as well as for mobility management decisions.

The RSSNR is a measure of the SNR of the received signal. The RSSNR typically ranges between −30 dB (best) to −20 dB (worst).

This disclosure is not limited to user data measured by the drone 522. The above-described user data includes downlink signal quality measurements, signals, and parameters that can be measured by an appropriate UE such as mobile phones and handsets for testing network quality of service (QoS) and quality of experience (QoE) along with appropriate applications such as NEMO HANDY™ handheld application from Keysight®. Alternatively, portable RF scanners such as the TSMA6 RF scanner from Rohde & Schwarz® can be used. Other equipment such as a USRP, a software defined radio (SDR) from Ettus Research® may also be used. In some embodiments, one or more of these devices can be mounted on a mobile robot, such as the drone 522, a UAV, or land rover robot depending upon the application and problem diagnosis requirements.

The signal strength and signal quality is measured using the drone 522 (or a mobile robot) that can move along all three spatial dimensions or along both elevation angles and azimuthal angles and that provides a 3D measurement of the coverage signal condition. The GPS position and time information are simultaneously logged by the computer system in the drone 522, such that the time at which the GPS position of the drone 522 is measured is recorded in relation to the GPS position. Additionally, the drone 522 uses one or more cameras to record still images or videos that can be used to reconstruct a 3D model of the terrain and buildings in the area of interest (namely, the affected region) using multi-view geometry and aerial photogrammetry.

In an embodiment of this disclosure, a LiDAR device is also mounted on the drone 522 to accurately scan the area of interest and create a 3D model of the area of interest. The 3D data from photogrammetry and LiDAR is combined to generate a detailed map of the area of interest containing an accurate representation of the buildings, 3D structures, trees, foliage, and terrain. This combined representation is more detailed and accurate than it is possible by either (LiDAR or photogrammetry) modality individually. For example, a LiDAR representation may provide be more accurate distances than photogrammetry, but the photogrammetry representation would not provide a more accurate visible phenomena (such as identification of color) than LiDAR. The photogrammetry representation can include more accurate information about the color of the surface of an object or obstacle, for example, to distinguish glass from concrete from wood. That is, the photographs and 3D scans can also be used to derive the material properties of the different features in the 3D map. This material properties information can be stored as additional properties of the features in the map. For example, if point clouds are used to represent the 3D structural information, then information related to the material properties may be added to each point in the point cloud along with position and color information. Similarly, information about materials can also be stored along with texture if a mesh-based model is used as a format for storing the 3D map of the area of interest.

In yet another embodiment of this disclosure, instead of 3D maps based on LiDAR modules, the server 300 can obtain mapping data (for example, a 3D spatial map) from an open geographic database (for example, OpenStreetMap® open source service) that can be used to examine the 3D maps of the area around the coverage weak spots. In this case, the generation of a 3D spatial map using LiDAR sensors is a procedure that can be excluded from or skipped at block 620, because the obstacle information is readily available to run ray-tracing scenarios and determine optimal placement of reflectors.

For ease of explanation, “first area” refers to the area of interest, and the 3D spatial map is a 3D map of the first area. The first area not only includes a zone (also referred to as “shadow zone”) blocked from a line of sight of a base station, but also includes a second area that surrounds the zone and that is within both a coverage area of the base station and the line of sight of the base station. In some circumstances, the zone and second area are mutually exclusive.

The 3D location tagged, signal strength/quality measurements and parameters, along with the 3D spatial map of the affected environment including the reconstructed terrain, foliage, trees, and building models with available material properties, the location information of the network nodes such as base stations (BS), integrated access backhaul (IAB), or active repeaters in the region constitute the 3D coverage measurement data. This 3D coverage measurement data is effectively a snapshot of the 3D signal strength and quality at a particular time instance (or data integrated over a relatively small period of time). The information regarding the location and type of network nodes in the region may be provided by the network operator.

In an embodiment of this disclosure, each such 3D coverage measurement dataset is constructed at different times, thereby forming a plurality of 3D coverage measurement datasets, to record the temporal dynamics of the wireless channel variation in the affected region. The spatially registered data along with the signal strength/quality measurements as a function of time constitutes the 3D coverage spatiotemporal measurement data.

The 3D coverage measurement data (either a snapshot in time or spatiotemporal data) contain information that can be used to diagnose potential problems related to insufficient network coverage, presence of RF blind spots or weak coverage, lack of data throughput, and high latency.

At blocks 530 and 630, the server 300 performs wireless coverage analysis and solution discovery, and can generate a corresponding rendering 532 for display on an electronic display device, as shown in block 530. That is, at blocks 530 and 630, the server 300 performs modeling and optimization. As an example of solution discovery, the area of interest depicted in the rendering 532 includes a mountable surface 534 to which a passive radio frequency reflective metasurface can be attached, for example, on the side of a building. The server 300 can identify the mountable surface 534 based on satisfaction of surface selection criteria, or based on user selection input.

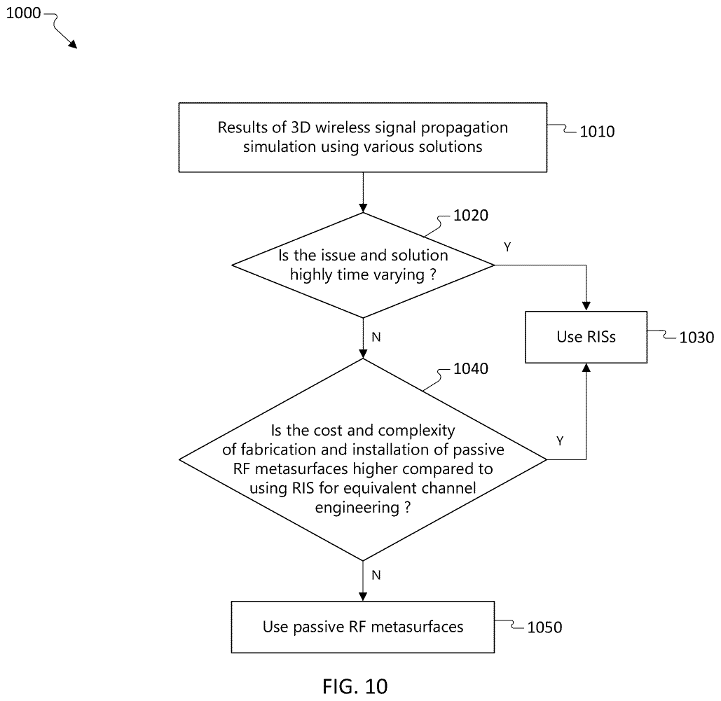

A mountable surface cannot always be identified, as some areas of interest do not include a surface suitable for a metasurface to attach. As part of solution discovery, the server 300 determines and recommends whether to use active RIS(s) or passive RF metasurface(s) for the specific scenario (for example, specific area of interest). As part of solution discovery, the end-to-end system 500, 600 determines and recommends the choice of metasurface to use considering the coverage issue time dynamics, and cost and complexity of fabrication and installation as described further below shown in FIG. 10.

As part of wireless coverage analysis, the 3D coverage measurement data can be rendered by representing the dynamic or static 3D signal strength and 3D signal quality data from the spatiotemporal or snapshot 3D coverage measurement data respectively using a density plot or 3D heat map overlaid on the reconstructed 3D model of the terrain, buildings, and network nodes represented using a suitable 3D data format such as a mesh or point cloud. To perform wireless coverage analysis, the server 300 performs 3D ray tracing for coverage optimization using a metasurface. The 3D ray tracing is shown in the rendering 532, including multiple existing beams or RF signals transmitted from a network node. The rendering 532 depicts a model of a passive RF metasurface (“model metasurface”) 536 added to the 3D map of the area of interest, particularly at a custom-placement within the second area surrounding the zone 518, to extend and improve the coverage in the zone 518 by reflecting, re-steering, and reshaping existing RF signals to illuminate the zone 518. The reflected beams that illuminate the zone 518 when reflected from the model metasurface 536, which is attached at a custom-placement on the mountable surface 534, can be represented by reflection paths 538 and/or a 3D density plot 539. The reflected beams propagate along the reflection paths 538, respectively, from the model metasurface 536. The length of the reflection paths 538 depends upon the separation distance from the model metasurface 536 to the receiver (such as the UE 514). That is, the model metasurface 536 provides a non-LoS path including a first portion having endpoints at the transmitter and the model metasurface 536, plus a second portion having endpoints at the model metasurface 536 and the receiver.

More particularly, the server 300 uses a 3D coverage measurement dataset (or the plurality of 3D coverage measurement datasets accumulated over different occasions) to perform wireless coverage analysis employing 3D ray tracing and solution discovery. The technique of 3D ray tracing is a standard tool in the field of wireless network design to analyze problems in the network. The 3D ray tracing technique can also be used for network design and network planning to provide coverage to economic development areas where planned buildings and planned skyscrapers will be erected. As an example within the server 300, the plurality of 3D coverage measurement datasets can be input to 3D wireless prediction software (such as Wireless InSite® by Remcom Inc.) for realistic modeling, analyzing and visualizing the channel properties, propagation paths, path loss and artifacts, and wireless device performance. As another example, the server 300 can execute custom wireless signal propagation and analysis software tools specifically focused on RIS technologies and RF metasurface technologies. In any case, the software tools that the server 300 uses are a part of the end-to-end system 500, 600 and service.

The end-to-end system 500, 600 according to embodiments of this disclosure is focused on how to use passive RF metasurfaces to reflect, re-steer, and reshape existing RF signals to illuminate the zones (such as zone 518) having weak or non-existent coverage. In other words, the wireless channel from the source node(s) to the UEs in the zone 518 is modified by tailor-made passive RF metasurfaces to create strong nLoS paths to extend and improve the coverage in the zone 518 (or zones) experiencing coverage problems, blind spots, and spotty connections.

At blocks 530 and 640, the server 300 designs the model metasurface 536 as a digital version of a real passive RF metasurface 542 that is not only customized for improving coverage in the zone 518, but also designed to be installed (for example, attached) at the custom-placement on the mountable surface 534 within the area of interest. In other words, the server 300 designs the passive RF metasurface 542.

At blocks 540 and 650, the custom-designed passive RF metasurface 542 is fabricated, for example, using an additive manufacturing system (referred simply as 3D printer) 544. The server 300 uses the 3D printer 544 to fabricate the metasurface 542. The server 300 can generate and send, to the 3D printer 544, parameters and instructions for controlling the 3D printer 544 to fabricate the metasurface 542. In some embodiments, these instructions can control components of the 3D printer 544a, such as a hot end 544h, a deposition nozzle, motor, or other component.

In an embodiment of this disclosure, tailor-made RF metasurfaces are 3D printed and installed in appropriate locations to improve the wireless signal coverage in weak coverage areas or coverage blind spots and mitigate the effects of shadow facing and path losses in urban cities, high-rise buildings, and spaces inside buildings in urban canyons. The RF metasurface 542 in this disclosure is generally a 3D surface (i.e., not a flat surface) with an irregular grid of hundreds to thousands of unit cells 546 that are capable of modifying (for example, passively tuning) the phase, amplitude, and polarization of the incident electromagnetic waves. These characteristics of the wavefront are changed relatively at each unit cell 546 due to the variation in the height, width, and breadth of the unit cells. The plurality of unis cells 546 includes first unit cells 546a that have a first dimensions, and second unit cells 546b that have second dimensions different from the first dimensions.

Additionally, a base metal surface may be added (for example, added to the unit cells) in some embodiments of the metasurface 542. Curvature of the base metal surface may be varied. In some embodiments, the base metal surface may also be 3D printed using nano-particles based gels. The conductivity (and loss) of such a metal surface depends on the quality of the gel. In some other embodiments, the metal surface can be composed of a continuous metal foil that can be attached to the 3D printed metasurface, which is an effective way of further reducing the cost while maintaining reflection loss.

At blocks 550 and 650, the fabricated metasurface 542 is added to the area of interest and installed on the mountable surface 534. The metasurface 542 enables the gNB 512 to transmits RF signals to UEs located in the zone 518 by transmitting a beam 552a along a non-LoS path, which includes a first portion from the gNB 512 the metasurface 542 and a second portion from the metasurface 542 to one or more UEs in the zone 518. The metasurface 542 is designed to reflect different impinging beams 552a, 554a, and 556a, which have different angles of incidence from each other. Particularly, the metasurface 542 is designed to reflect the impinging first beam 552a, thereby redirecting at least some energy of the impinging beam 552a as one or more reflected beams 552b-552c. The metasurface 542 is designed to redirect at least some energy of the impinging second beam 554a as one or more second reflected beams 554b-554c; and the metasurface 542 is designed to redirect at least some energy of the impinging third beam 556a as one or more third reflected beams 556b-556c. In some embodiments, the metasurface 542 is designed such that six different changes of angle result from the six reflected beams relative to their impinging beams, respectively. The zone 518 is subjected to RF energy of the reflected beams 552b-552c, 554b-554c, and 556b-556c, which illuminates the zone 518.

At blocks 560 and 660, the server 300 performs solution verification and reporting, for example, by repurposing the problem discovery procedures of blocks 510 and 610, or by repurposing the 3D signal coverage measurement procedures of blocks 520 and 620. The user 519 of the UE 514 located in the zone 518 may state “It's all good!” or otherwise report an elimination or absences of any coverage problem to the network operator. The drone 522 can be redeployed to the area of interest to measure the coverage as verification that the coverage issue is solved.

FIG. 7 illustrates 3D map 700 of an area of interest, according to embodiments of this disclosure. The embodiment of the 3D map 700 of shown in FIGURE. 7 is for illustration only, and other embodiments could be used without departing from the scope of this disclosure. The 3D map 700 can be the 3D layout of the area-of-interest, which the server 300 generates based on mapping data the server obtained.

The server 300 can generate the 3D map 700 using LiDAR, camera, and GPS sensors to record 3D point cloud, optical ground truth, and position and time. Additionally, the 3D map 700 can be generated using photogrammetry to guess the material of the buildings. For example, if a reflection is from concrete, then the server 300 can generate approximate attenuation properties of the material if the server 300 can obtain additional information about the concrete such as the thickness, porosity, etc.

The server 300 can use 3D point cloud along with material information to generate approximate electrical properties of obstacles. Examples of a 3D point cloud include the (x₀, y₀) point cloud corresponding to the location of a network node (for example, gNB); and the {(x₁, y₁), (x₂, y₂), . . . (xₙ, yₙ)} set of point clouds that each corresponds to the location of a different obstacle (for example, a building or tree).

Based on the location of the gNB and locations of obstacles, the server 300 can perform 3D ray tracing to estimate signal weak spots, shown as a shadow zone 718 (similar to the zone 518 of FIG. 5). The server 300 can use commercial software to estimate propagation paths, path loss, and other artifacts. For example, the server 300 can identify the coordinates (x, y) as a weak spot or as a point cloud that represents the shadow zone 718. In this example, the shadow zone 718 is a section of street blocked from a LoS of the gNB.

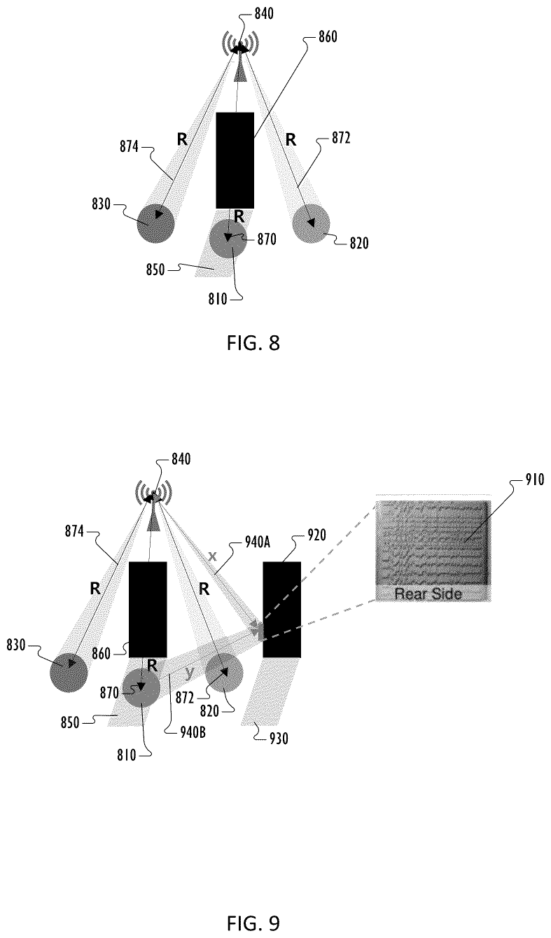

FIG. 8 illustrates multiple coverage areas 810, 820, 830 of a gNB 840 and a shadow zone 850 of poor coverage caused by an obstacle 860 in the line-of-sight (LoS) path 870 between the gNB 840 (as RF signal transmitter) and a radio signal receiver located in the shadow zone 850. The shadow zone 850 covers (for example, includes an entirety of) the first coverage area 810 that experiences the poor coverage due to the obstacle 860 blocking, preventing, or vitiating signals transmitted along the first LoS path 870. Each of the second and third coverage areas 820 and 830 receives high quality coverage from signals transmitted along second and third LoS paths 872 and 874, respectively. The multiple coverage areas 810, 820, 830 of the gNB 840 can be served by different beams that the gNB 840 transmits in three different directions.

FIG. 9 illustrates custom placement of a custom-designed passive RF metasurface 910 to create strong non-LoS paths for illuminating weak coverage areas and coverage blind spot areas, according to embodiments of this disclosure. FIG. 9 includes all of the components of FIG. 8. The custom placement of the metasurface 910 can be on a mountable surface of a building 920 (such as another obstacle) that creates a second shadow zone 930, but in this example, the second shadow zone 930 does not overlap any of the multiple coverage areas 810, 820, 830 of the gNB 840.

The metasurface 910 is composed from meta material, which includes artificially crated materials that have different permittivity and different permeability. The metasurface 910 does not boost (for example, amplify) signal power of an impinging beam (or waveform) 940. The impinging beam 940a is transmitted from the gNB 840 along a first portion of a non-LoS path that is an LoS path to the metasurface 910. Then, the metasurface 910 reflects the impinging beam 940a as reflected beam 940b along a second portion of the non-LoS that this is another LoS path from the metasurface 910 to the first coverage area 810. The reflected beam 940B increases SNR in the weak coverage areas and coverage blind spot areas, such as in the second coverage area 810 overlapped by the shadow zone 850.

For ease of explanation, the beams along LoS paths and non-LoS paths are described as being transmitted from a gNB and received at a UE, however, it is understood that this disclosure analogously applies to beams transmitted from a UE to the gNB that are reflected by the passive RF metasurface.

FIG. 10 illustrates a method 1000 for determining whether to use passive RF metasurfaces or RISs, in accordance with an embodiment of this disclosure. The embodiment of the method 1000 shown in FIG. 10 is for illustration only, and other embodiments could be used without departing from the scope of this disclosure. The method 1000 can be executed by at least one processor of an electronic device, such as the processor of the server 300 of FIG. 3, performing the solution discovery procedures.

At block 1010, the server 300 obtains (for example, generates or receives from an external device) results of 3D wireless signal propagation simulation using various solutions.

At block 1020, the server 300 determines if the problem discovered and solution are highly time varying, for example, greater than a threshold time variance. This determination is made based on the optimization of time dynamics of the coverage issue and solution, fabrication complexity and cost, and installation complexity and cost. For example, if the wireless connectivity issues are somewhat static then employing passive RF metasurface(s) may be a better solution than RIS(s). On the other hand, if the fading and path loss effects are significantly time-varying, then the solution may include using the RIS that can adapt to the time-varying, changing channel conditions.

At block 1030, a determination to use RISs results, in response to a determination that the problem discovered is highly time varying. That is, the server 300 recommends using RISs as the solution for the coverage problems discovered. For example, time-varying coverage weakness can be due to traffic congestion (for example, pedestrian traffic, or people in moving vehicles), and the amount of a channel's capacity that is used in a particular cell during business hours or during a lunch hour or during a large crowd gathering (e.g., NBA game) can be highly time varying. An RIS controller can provide time-varying bias voltages to change the reflections that RISs generate during different periods of a day, which is unlike the metasurface configured with reflection capabilities that are static (time-invariant).

At block 1040, in response to a determination that the problem discovered is not highly time varying, the server 300 determines if the cost and complexity of fabrication and installation of passive RF metasurfaces is greater compared to that of an RIS for equivalent channel engineering. In an example scenario, the fabrication and installation cost and complexity may favor using active RIS(s) rather than passive RF metasurface(s). For example, usually, an equivalent level of wireless channel engineering can be achieved by employing a slightly larger number of passive RF metasurfaces instead of using active RISs. The slightly larger number of passive RF metasurfaces can be fabricated at a much lower cost than fabricating the active RISs, thus making passive RF metasurfaces the better choice as the solution. However, if the situation requires a significantly greater number of passive RF metasurfaces compared to RISs for comparable wireless channel engineering capability, then the cost and complexity of fabrication and installation may favor active RISs as the solution.

In response to a positive determination result at block 1040, the method 1000 proceeds to block 1030 at which the determination to use RISs results (for example, a determination not to use passive RF metasurfaces). At block 1050, an alternate determination to use passive RF metasurfaces results, in response to a determination that the cost and complexity of fabrication and installation of passive RF metasurfaces is not greater compared to that of an RIS for equivalent channel engineering.

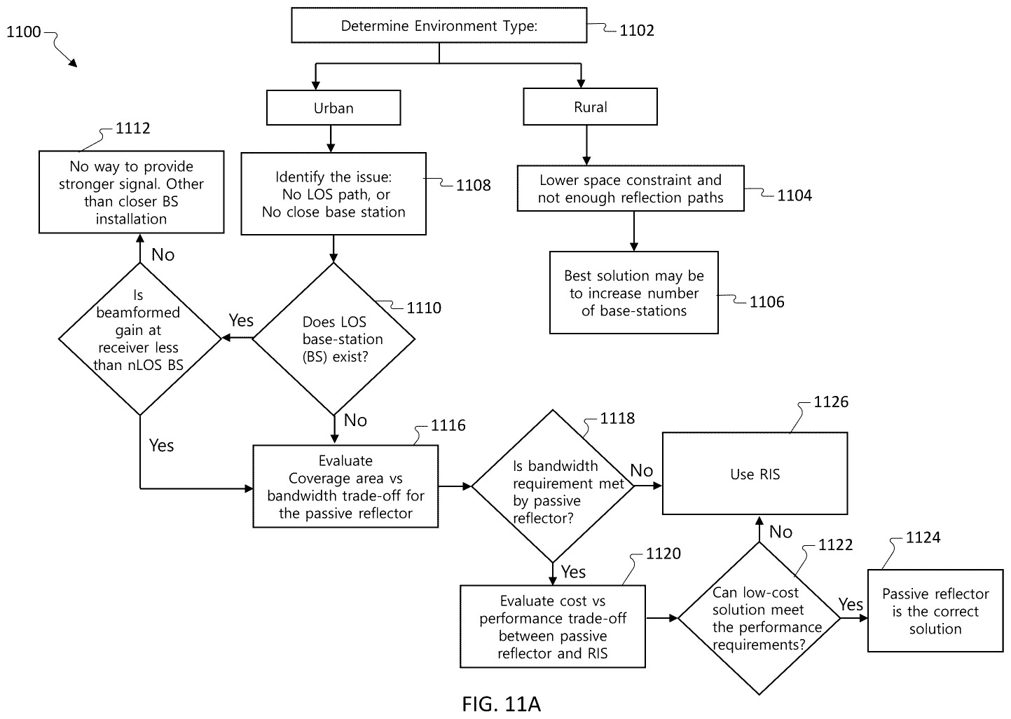

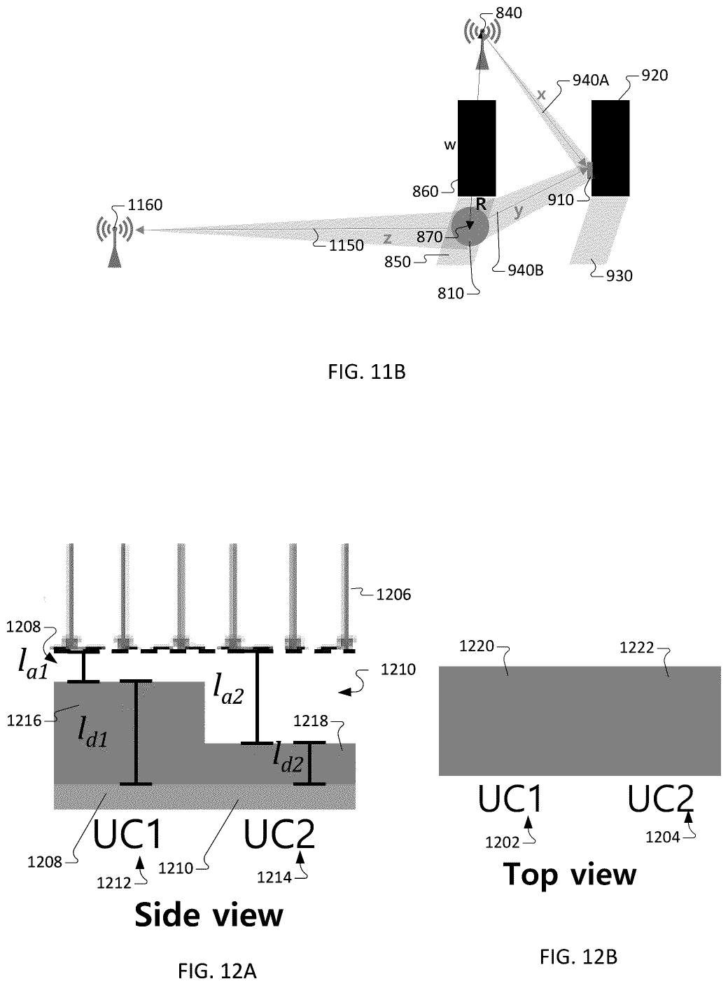

FIG. 11A illustrates a method 1100 for determining whether to use passive RF metasurfaces to solve a coverage problem based on the type of environment, according to embodiments of this disclosure. The embodiment of the method 1100 shown in FIGURE. 11A is for illustration only, and other embodiments could be used without departing from the scope of this disclosure.

Apart from determination of time-varying/static coverage issues, the environment type also affects the feasibility of passive reflectors. The method 1100 includes procedures to be undertaken to determine whether passive reflector can improve the signal strength in shadow zones such as the zone 518 of FIG. 5, the zone 718 of FIG. 7, or the first coverage area 810 overlapped by the shadow zone 850 of FIG. 8. The selection condition to select the passive metasurface reflector as the best solution is contingent upon satisfying multiple criteria, as described further below.

At block 1102, we determine whether we are targeting a rural or urban environment. Particularly, the server 300 identifies a coverage area of interest, a location of surrounding existing base stations, and LIDAR map of surfaces where a potential metasurface can be attached. Within rural environments, an advantage is that usually there are line-of-sight paths to base stations.

At block 1104, the rural environment is characterized by a lower space constraint and not enough reflection paths. If there is no LOS path within the rural environment, usually there are very few (if any) tall obstacles (having a mountable surface onto which a metasurface can be attached) to reflect the signal into a weak coverage area. Hence, as shown at block 1106, in most cases the best way to improve coverage in such rural environment zones is to install additional base stations at closer distances.

When it comes to urban environments, there are a variety of criteria that need to be evaluated.

Firstly, at block 1108, the server 300 evaluates whether there exists a line of sight path that is directly from the weak coverage area to a gNB that is in the vicinity. If the LoS path does exist, the method 1100 proceeds to block 1110 to determine whether the LoS path is to the closest gNB in the vicinity.

Refer temporarily to FIG. 11B, which illustrates the first coverage area 810 as a shadow zone having two LoS paths 870 and 1150 to two gNBs 840 and 1160, and a second portion 940b of a non-LoS path to a metasurface 910. FIG. 11B includes multiple components 840, 850, 860, 870,910, 920, 930, and 940a-940b from FIG. 9. The distance x and distance y represent the distance propagated by the impinging beam 940a and reflected beam 940b, respectively along the lengths of the first portion and second portion of the non-LoS path. The separation distance w from the first coverage area 810 to the first gNB 840 is less than the separation distance z to the second gNB 1160, and is greater than the combined length (x+y) of the non-LoS path 940a-940b.

Refer back to FIGURE. 11A. At block 1112, if no LoS path exists or if no gNB is close (for example, less than or equal to the distance w of FIG. 11B) to form both the first and second portions of a non-LoS path, then it is improbable that any passive reflector solution of RIS can make the signal quality better. In this case, the best solution is to have additional base-stations installed closer to the shadow zone.

In case the LOS base-station is geometrically not the closest base-station, then it may be possible to reflect signals from a non-LOS base-station 840 to improve the signal level in the weak coverage area 810. If reflector is determined as an effective solution, the method 1100 proceeds to block 1116 to evaluate the coverage versus bandwidth trade-offs. Passive reflectors, which produce non-tunable fixed beams, tend reflect so over a narrow frequency range. This is because, as the frequency changes, the reflection phase from each unit cell also changes as shown in FIGS. 12A-12B. This changes the direction of the reflected beams, which means that the reflected beams may not cover the first coverage area 810 (within the shadow zone 850) over very wide bands of operation.

If the bandwidth required is typically narrow, and if the fixed beam solution still illuminates the shadowed coverage area 810, then method proceeds from block 1118 to block 1120 because a passive metasurface reflector could be a reasonable solution. The passive metasurface reflector is attractive because of its lower cost. In turn, the overall beam shape and performance may not be as good as actively tunable solutions, such as the RISs that are much costlier.

If the performance requirement is not too stringent, and if a low-cost solution is acceptable, then the method 1100 proceeds from block 1122 to block 1124 at which the passive metasurface reflector is the selected (for example as the best choice) for providing the coverage enhancement. Otherwise, the method 1100 proceeds from block 1122 to block 1126 at which alternative solutions like the RIS should be considered. That is, the determination to use a metasurface at block 1124 can be the same as block 1050 of FIG. 10, and the determination to use an RIS at block 1126 can be the same as block 1030 of FIG. 10.

FIGS. 12A and 12B respectively illustrate a side view and a top view of two examples of unit cells 1202 and 1204 (labeled UC1 and UC2) of a passive RF metasurface, according to embodiments of this disclosure. The embodiment of the unit cells 1202 and 1204 shown in FIGS. 12A-12B is for illustration only, and other embodiments could be used without departing from the scope of this disclosure.

An incident plane wave 1206 impinges on the unit cells 1202 and 1204 at a normal angle (such as 90 degrees) of incidence. The thickness l_{d1} dimension of the first unit cell 1202 is greater than the thickness l_{d2} dimension of the second unit cell 1204, so when dielectric differences exist when the unit cells 1202 and 1204 are composed from identical dielectric material. Due to dielectric differences, the first unit cell 1202 produces a different reflection magnitude and phase change than the second unit cell 1204 produces, as described more particularly below.

Once the design of the structure of the passive RF metasurface and the optimal number of surfaces to use (for example, an optimal number of unit cells that form the metasurface) have been determined (for example, by the server 300) based on the materials used in the design and optimization process (for example, blocks 530 and 630-640), the server generates a computer aided design (CAD) drawing of the metasurface.

Different geometries of RF metasurface can produce advantageous phase variations to generate different reflected beam directions. The reflected beam directions and reflected power of each reflected beam primarily depend upon three factors: angle of incidence, arrangement of unit cells, and size of the passive reflector. Angle of incidence is usually known (such as predetermined) because the server 300 knows the location of the gNB and the location of the metasurface that is the reflector. That is, the server 300 can determine the angle of incidence before an impinging beam such as the incident plane wave 1206 impinges onto the metasurface. The server determines the arrangement of unit cells based on a desired beam direction for a desired reflected beam, and based on magnitude and a phase reflection that each individual unit cell produces. The server 300 calculates a predetermined reflection power according to throughput requirements, such as a throughput thresholds associated with strong signal quality and strong signal strength. Then, the size of the passive metasurface is determined based on the predetermined reflection power.

In order to determine the arrangement of unit cells, it is advantageous to understand how a metasurface's unit cell generates different reflected magnitudes and phases. Each unit cell 1202, 1204 includes an air layer 1208, 1211, a metal layer 1212, 1214 that forms the metasurface's metal surface, and a dielectric layer 1216, 1218 disposed intermediately between the air layer and the metal layer. A top surface 1220, 1222 of the dielectric layer 1216, 1218 interfaces with (or contacts) a bottom surface of the air layer 1208, 1211. A bottom surface of the dielectric layer 1216, 1218 interfaces with a top surface of the dielectric layer 1216, 1218. The dimensions lₐₙ and l_{dn} represent length of the air layer and dielectric layer, respectively, which are different for different unit-cells. A normally-incident plane wave 1206, causes a reflection from the unit cell surface with the following different phases. The reflection phase due to any unit cell can be expressed by Equation 1, where n denotes an index identifying an individual unit cell of the metasurface, where λ_{g} denotes the guided wavelength as expressed by Equation 2, and λ₀ denotes the free-space wavelength a expressed by Equation 3, and εᵣ denotes the permittivity of the substrate. In Equation 3, f₀ denotes the design frequency and c is the speed of light (3×10⁸ m/s). Hence different substrate permittivity and dielectric thickness can help to give all possible phase variations in the range 0° to 360°.

$$\frac{2 π}{{λ}_{0}} * 2 {l}_{a n} + \frac{2 π}{{λ}_{g}} * 2 {l}_{d n} + π \qquad ( 1 )$$

$${λ}_{g} = \frac{{λ}_{0}}{\sqrt{{ε}_{r}}} \qquad ( 2 )$$

$${λ}_{0} = \frac{c}{{f}_{0}} \qquad ( 3 )$$

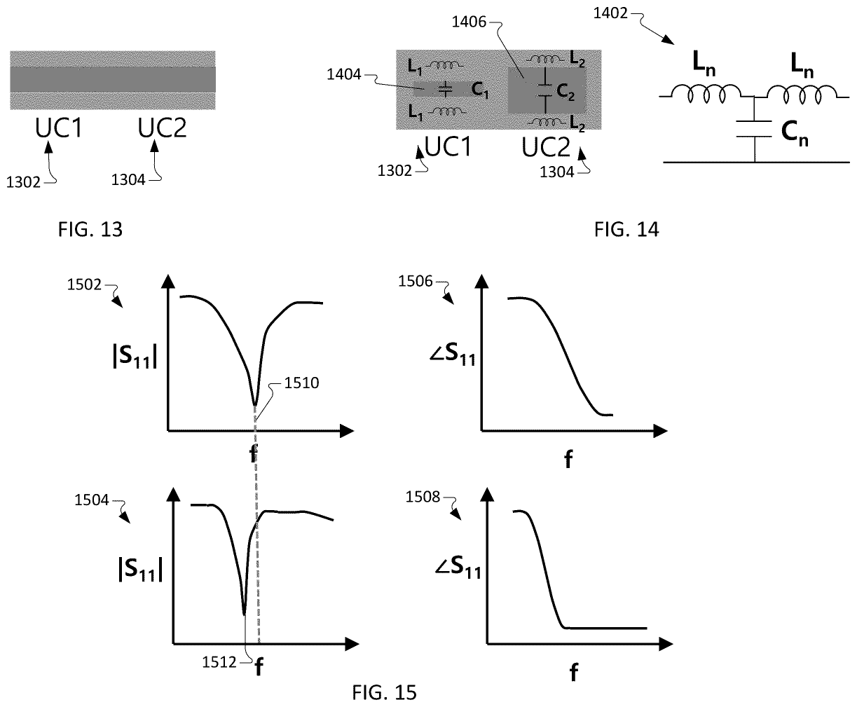

Dielectric differences is not the only characteristic that enables the metasurface to able to perform a phase change. In another embodiment, the RF metasurface (as a passive reflector) has a fixed (or uniform) dielectric height, but the phase change is obtained though different gratings in the metal surface. FIG. 13 illustrates a side view of two example unit cells 1302 and 1304 that have different metal gratings, according to embodiments of this disclosure. The unit cells 1302 and 1304 form part of a passive RF metasurface, according to embodiments of this disclosure. FIG. 13 shows that each of the unit cells 1302 and 1304 includes a lower metal layer, an upper metal layer, an intermediate dielectric layer having a top surface interfaced with the bottom surface of the upper metal layer and having a bottom surface interfaced with a top surface of the lower metal layer. The lower metal layer has a first uniform thickness, the upper metal layer has a second uniform thickness, an intermediate dielectric layer has a third uniform thickness that can be the same as or different from one or both of the first and second uniform thicknesses.

FIG. 14 illustrates a top-view of the two unit cells 1302 and 1304 of FIG. 13 and a corresponding equivalent circuit 1402, according to embodiments of this disclosure. The embodiment of the unit cells 1302 and 1304 shown in FIGS. 13-14 is for illustration only, and other embodiments could be used without departing from the scope of this disclosure.

Each of the unit cells 1302 and 1304 includes a via (such as a hole) 1404 and 1406 from the top surface of the upper metal layer through the bottom surface of the bottom metal layer, through the entire thickness of the metasurface. Each of the vias 1404 and 1406 functions as a capacitor C₁ and C₂, respectively, wherein the dielectric material of the capacitor is a gas such as air. In the first unit cell 1302, the first via 1404 has a polygonal shape, such as a rectangular tube with two short sides and two long sides. The capacitor C₁ is defined by two conductors (for example, two plates) that function as inductors L₁ and L₁ and that are separated by the first via 1404. For example, the first conductor of the capacitor C₁ can include half of the first unit cell 1302, and the second conductor of the capacitor C₁ can include the other half of the first unit cell 1302. Analogously, the second capacitor C₂ is defined by two conductors that function as second inductors L₂ and L₂ and that are separated by the polygonal-shaped second via 1406. In this example, the second via 1406 is longer and wider than the first via 1404, as such, different unit cells can include different capacitances of C₁ and C₂ and different inductances of L₂ and L₂.

The equivalent circuit 1402 schematically represents a unit cell that is identified by the index n. The capacitor Cₙ bisects a series connection of its two conductors, for example, inductors Lₙ and Lₙ of the n^{th} unit cell.

The different unit cells 1302 and 1304 can produce different reflection magnitudes and phase. Unlike the simple dielectric thickness varying technique of FIGS. 12A-12B, in this case following graphical understanding is used to distinguish between magnitude and phase responses. According to the equivalent circuit 1402, the resonant frequency of the n^{th} unit cell can be expressed by Equation 4, where L_{eq} denotes the inductance of the equivalent circuit 1402, and where C_{eq} denotes the capacitance of the equivalent circuit 1402.

$${f}_{n} = \frac{1}{2 π \sqrt{{L}_{e q} {C}_{e q}}} \qquad ( 4 )$$

The resonance frequency indicates the point where there is no reactive component of impedance and only resistive component exists. Around the resonance point, the inductive nature of the impedance changes to capacitive and vice-versa. Owing to this, a large phase change is encountered. The slope of the phase change is denoted as the quality factor (Q) of the n^{th} unit-cell circuit, which can be expressed according to Equation 5, where R is the resistive loss in the circuit.

$${Q}_{n} = \frac{1}{R} \sqrt{\frac{{L}_{eq}}{{C}_{eq}}} \qquad ( 5 )$$

FIG. 15 illustrates an example of magnitude response 1502, 1504 and phase response 1506, 1508 for two unit-cells' 1302 and 1304 geometries in FIGS. 13 and 14.

The Q determines the bandwidth of the circuit, or how quickly or slowly the magnitude response changes. A larger bandwidth (lower Q) means phase change is more gradual and vice-versa. FIG. 8 shows an example magnitude and phase curve for two unit cells, which due to different grating geometries, exhibit different response at the same frequency. Such technique can thus be used to generate full 360° phase variations at any given frequency which is advantageous for different surface impedance and beam direction cases.

Particularly, the first unit cell 1302 has a wider bandwidth (smaller Q) than the second unit cell 1304 and resonates at a slightly different frequency. To depict this slightly different frequency, the line 1510 indicates a resonance frequency of the magnitude response 1502, but the line 1510 does not align with the resonance frequency 1512 of the other magnitude response 1504. This leads to a different magnitude and phase response for both the unit cells.

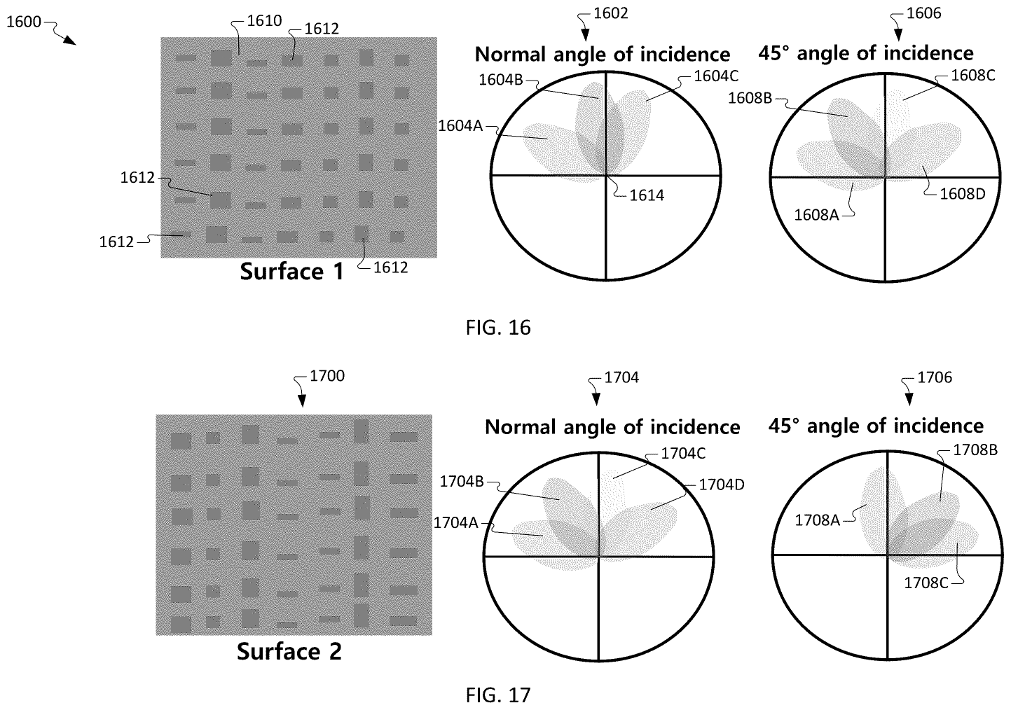

FIGS. 16, 17, and 18 illustrate multiple examples of a metasurface and one or more reflected beams resulting from an incident beam at two different angles of incidence, according to embodiments of this disclosure. Particularly, FIG. 16 illustrates a first metasurface 1600, a first graph 1602 of multiple reflected beams 1604a-1604c resulting from an impinging beam upon the first metasurface 1600 at a normal) (90°) angle of incidence, and a second graph 1606 of multiple reflected beams 1608a-1608d resulting from an impinging beam upon the second metasurface 1600 at a forty-five degrees) (45°) angle of incidence.

The first metasurface 1600 can be a finite surface 1610 having a specified number of unit cells. In this example, the unit cells of the first metasurface 1600 can include respective vias 1612 that are differently sized, similar to the unit cells 1302 and 1304 of FIGS. 13-14.

The origin 1614 of the graph 1602 represents the location where the incident beam impinges upon the first metasurface 1600. Although the incident beam can be wide enough to simultaneously impinge upon multiple unit cells (each identified by a corresponding via 1612), for ease of understanding, the origin 1614 also represents the location from which the reflected beams 1604a-1604c emanate according to different phase angle changes. The three reflected beams 1604a-1604c are generated concurrently from an incident beam impinging upon the first metasurface 1600 at the normal-angle of incidence. That is, power of the incident signal is divided among the three concurrently reflected beams 1604a-1604c. The power of each of the three reflected beams 1604a-1604c can be equal to each other or unevenly distributed. Analogously, the graph 1604 shows four reflected beams 1608a-1608d are generated concurrently from another incident beam impinging upon the first metasurface 1600 at the 45° at the normal-angle of incidence.

FIG. 17 illustrates another example of a second metasurface 1700, a third graph 1702 of multiple reflected beams 1704a-1704d resulting from an impinging beam upon the second metasurface 1700 at a normal) (90°) angle of incidence, and a fourth graph 1706 of multiple reflected beams 1708a-1708c resulting from an impinging beam upon the second metasurface 1600 at a forty-five degrees) (45°) angle of incidence.

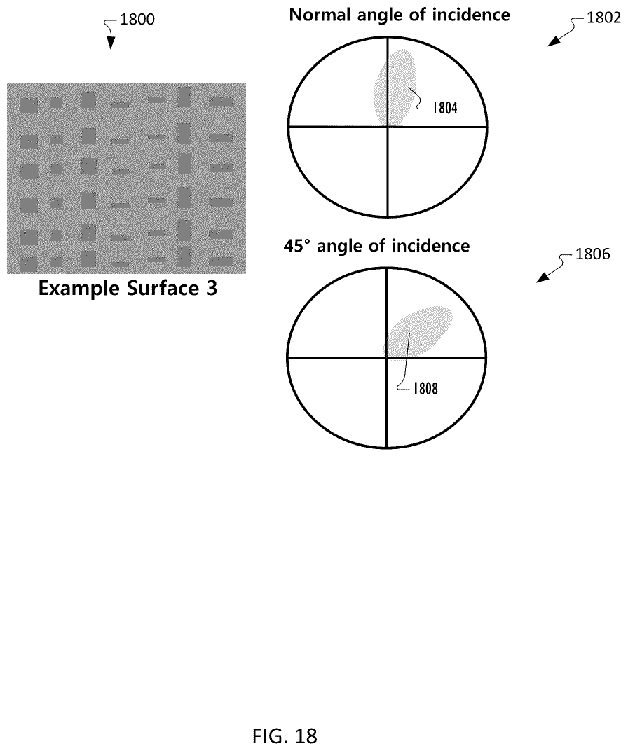

FIG. 18 illustrates yet another example of a third metasurface 1800, a fifth graph 1802 of a single reflected beam 1804 resulting from an impinging beam upon the third metasurface 1800 at a normal) (90°) angle of incidence, and a sixth graph 1806 of a single reflected beams 1808 resulting from an impinging beam upon the third metasurface 1800 at a forty-five degrees) (45°) angle of incidence. The reflected beams 1804 and 1808 can emanate according to different phase angle changes.

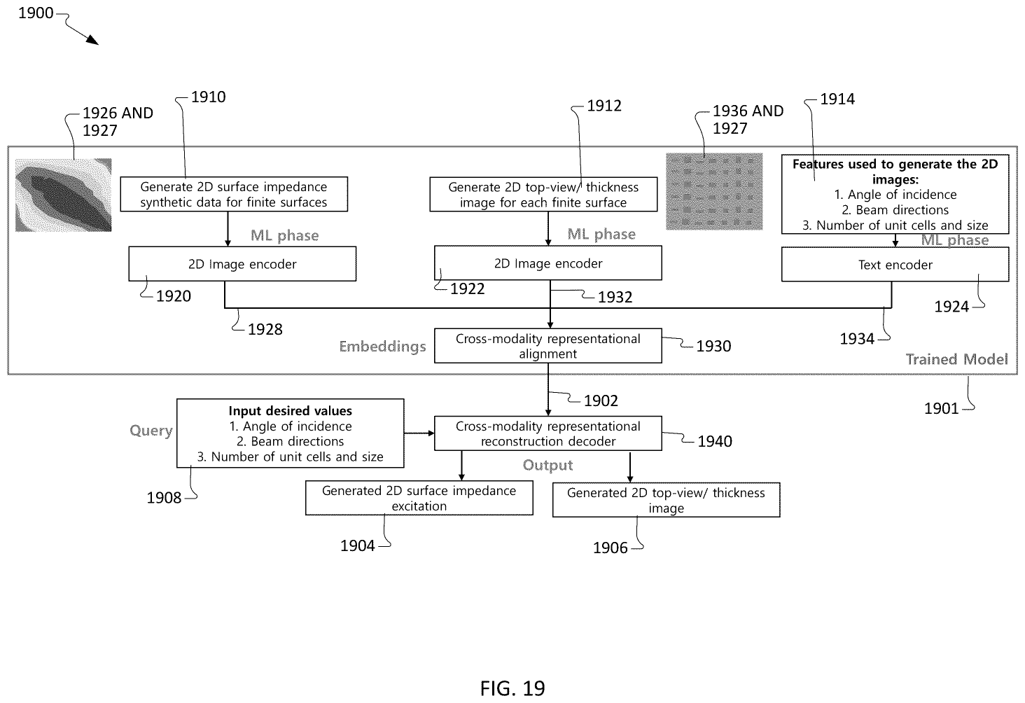

FIG. 19 illustrates a method 1900 for training 1901 an encoder-decoder ML model 1902 and applying the trained encoder-decoder ML model 1902 to generate outputs 1904 and 1906 based on an input query 1908, according to embodiments of this disclosure. The embodiment of the method 1900 shown in FIG. 19 is for illustration only, and other embodiments could be used without departing from the scope of this disclosure.

Once the unit-cell response for various (for example, all) possible configurations and phase combinations are analyzed, the next step is to do a periodic floquet-mode simulation to account for mutual coupling effects of neighboring unit-cells. The floquet-mode assumes an infinite size of the periodic surface and simulates the magnitude and phase response when there are mutual coupling effects. Once the floquet mode simulations are complete for all unit cell configurations, the next step is to determine the finite metasurface reflector aperture. Non-machine learning based optimization techniques are used to compute unit cell arrangement for each use-case. However, this process is very resource intensive and time consuming when the size of the reflector surface is very large. Particularly, the direction and number of reflected beams are largely dependent on the angle of incidence. So, a surface generated for a fixed direction of beams is undesirable (for example, the server 300 cannot recommend such surface as the solution to be used) if the angle of incidence changes (for example, time-varying), or if the size of the surface is changed.

This disclosure provides a novel ML-based technique that is based on joint text and image learning and uses an encoder-decoder architecture. That is, the ML model 1902 uses an encoder-decoder ML architecture with joint learning based on text and image data. To outline the complexity of the problem solved by the method 1900, the input variables, trainable features, and desired outputs are listed below. The method 1900 can be a pipeline for model training and output generation. Based on the input variables and the trained model, embodiments of this disclosure can query the trained model 1902 that can generate outputs 1904-1906 that can help to determine exact unit cell placement for any given scenario. The input data to the ML model 1902 should include of the following parameters: angle of incidence, reflected beam directions, and size of the passive reflector.

The training 1901 of the ML model 1902 can be referred to as block 1901. To train the encoder-decoder ML model 1902, at blocks 1910, 1912, and 1914, the server 300 obtains (for example, generates) training data and inputs the obtained training data into the model, such as into the encoders 1920, 1922, and 1924. To generate synthetic data that is used to train the model, the server 300 uses full-wave simulations. At block 1910, the server 300 processes one or more images 1926 of the surface impedance of the metasurface to generate 2D surface impedance synthetic data for finite surfaces. At block 1920, a first 2D image encoder, which is configured to encode images of 2D surface impedances, encodes the image 1926 of the metasurface 1927. The first encoded image 1928 of the metasurface's 1927 2D surface impedances is output to an embedder 1930 that is configured to apply cross-modality representational alignment.

At block 1912, the server 300 analyzes one or more images 1936 of the metasurface 1927 to generate an image of a 2D top-view as well as an image of the 2D side-view (or thickness-view) of the metasurface. Among the images 1936, the 2D top-view images can be similar to the top views of the metasurfaces 1600, 1700, and 1800 shown in FIGS. 16-18. Among the images 1936, the 2D side-view can be similar to the side views shown in FIGS. 12A and 13. At block 1922, a second 2D image encoder, which is configured to encode spatial images of finite surfaces, encodes the training data generated at block 1912, for example, encoding top-view and side-view images 1936 of the metasurface 1927. The second encoded image 1932 of the spatial features of the metasurface 1927 is output to the embedder 1930 applies cross-modality representational alignment to the 1928, 1932, and 1934.

At block 1914, server 300 identifies features 1914 used to generate the 2D images of the finite surface. For example, the metasurface 1927 can be a real tangible device that was previously designed (with or without ML) and fabricated for solving a real coverage problem. The parameters used to design and fabricate the metasurface 1927 are the features 1914 identified, including an angle of incidence, reflected beam directions, and number of unit cells, and size of unit cells. The text encoder 1924 encodes the identified features 1914, and sends the encoded text 1934 to the embedder 1930. The embedder 1930 applies cross-modality representational alignment to the first encoded image 1928, second encoded image 1932, and encoded text 1934, thereby aligning the metasurface 1927 depicted in the images of the training data and embedding the features 1914 with the image data. The encoded output from the embedder 1930 is the encoder-decoder ML model 1902.

For ease of summarization of block 1901, it is understood that block 1901 includes other blocks 1910-1930 of the method 1900. The training data (at block 1912) includes a 2D image of randomly arranged unit cells in the top-view or side-view denoting different dielectric thickness. These unit cell structures produce (at block 1910) a 2D impedance excitation of the surface, which is directly responsible for different beam directions in the far-field. The two 2D images are processed through (at blocks 1920 and 1922) individual ML based image encoders to generate training features. Along with these images, the training data (at block 1914) includes prior data of the angle of incidence, size of the reflector used to get the results, and the resultant reflected beam directions. This text input is processed through another ML-based text encoder 1924 to generate yet another set of trainable features. Eventually, the training features (1928, 1932, and 1934) include both image data and text data. Hence, the server 300 (using the embedder 1930) performs joint-leaning to develop embeddings that rely on cross-modality representational alignments. The output of this block 1901 is the trained ML model 1902.

After the ML model has been trained, the trained model 1902 can be used to custom-design a metasurface based on a query of desired values. The trained ML model is supplied with queries 1908, which can include identical parameters as the training dataset of block 1914, in that the query 1908 will specify the size of the aperture, number and direction of the reflected beams, and the angle of incidence. The server 300 inputs the trained ML model 1902 and query 1908 through a pre-trained decoder architecture to output two sets of 2D images. As the output 1904, a first image is the impedance excitation of the surface which determines beam directions. As the output 1906, a second image is the 2D top-view which shows gratings in the metal surface, or the 2D side-view of different dielectric heights which relates to placement of the individual unit-cells.

The server 300 can include a decoder 1940 configured apply cross-modality representational reconstruction to the trained ML model 1902 received, and thereby generate decoded output 1904 and 1906 in response to receiving the query 1908. The first decoded output 1904 includes generated 2D surface impedance excitation, which can be a reconstruction of the image 1926. The second decoded output 1906 includes a generated 2D top-view (and/or side-view) image, which can be a reconstruction of the image 1936. The output 1906 can be a CAD drawing of such passive metasurface apertures, which can be constructed using ML techniques based on known angle of incidence, desired beam directions and surface size are produced. These CAD drawings are used to fabricate the required number of RF metasurfaces using 3D printers.

In some embodiments, the server 300 executes the decoder 1940 based on an assumption that the decoder model is pre-trained using zero-shot learning. In another embodiment, the decoder 1940 is supplied with examples of query and outputs to make it a few-shot or supervised learning.

In an embodiment of this disclosure, the fabricated passive RF metasurfaces (or alternatively RISs) are installed at the appropriate locations as determined by the 3D wireless propagation simulation in the design and optimization process (for example, blocks 530 and 630-640). A robot (such as drone 522, UAV, or land rover) is sent back to the location of interest to measure the wireless channel conditions following the installation, for example, a part of a verification procedure. The robot regenerates a 3D coverage measurement data including various time and coordinate-tagged signal strength and parameters information in the 3D space. The new 3D coverage measurement data is compared with the earlier data to determine whether the coverage issue has been fixed or not and a corresponding report is generated by the system.

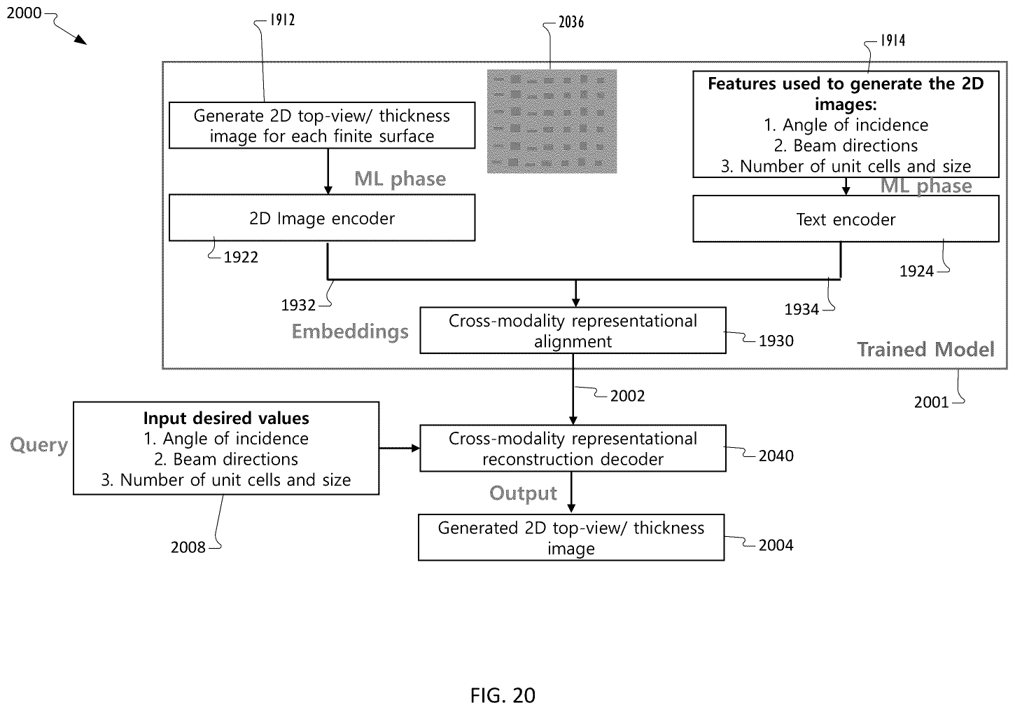

FIG. 20 illustrates a method 2000 for training 2001 a simplified encoder-decoder ML model 2002 and applying the trained simplified encoder-decoder ML model 1902 to generate an output 2004 based on an input query 2008, according to embodiments of this disclosure. The embodiment of the method 2000 shown in FIGURE. 20 is for illustration only, and other embodiments could be used without departing from the scope of this disclosure. The method 2000 includes similar procedures as the method 1900, except the training 2001 does not include the procedures of blocks 1910 and 1920, and the training data for the training 2001 does not include the images of 2D surface impedances, such as the image 1926 of the metasurface 1927. The training 2001 includes a subset of the procedures from the training 1901 of FIGURE. 19, particularly, blocks 1912, 1914, 1922, and 1924. The spatial image data 2036 as training data for the training 2001 can be the same top-view or side-view image 1936 from FIG. 19. To avoid duplicative description, it is understood that the procedures of blocks 2001, 2004, 2008, and 2040 can be the similar to corresponding procedures of blocks 1901, 1904, 1908, and 1940 of FIG. 19.

In other words, the ML model 1902 of FIG. 19 can be further simplified into just one image encoder and one text encoder, as shown in the simplified ML model 2002. This is because the text encoding specifying beam directions directly influences the 2D impedance pattern. As a result, when the parameter values are supplied are supplied in the query 2008 for the parameter(s) corresponding to required beam directions, then the surface impedance is the result of the passive reflector generating beams in those directions. So, just one image output of 2D top view or thickness view is sufficient to fabricate the reflector model. The simplified ML architecture shown in FIG. 20.

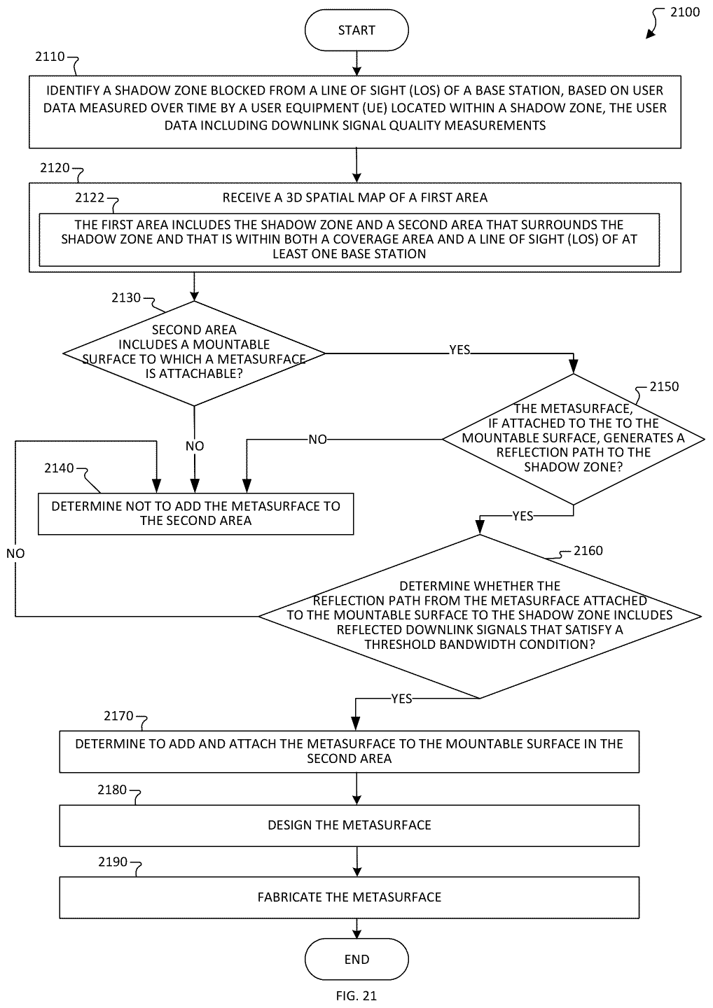

FIG. 21 illustrates a method 2100 for improving wireless coverage in shadowed zones using passive RF metasurfaces from an end-to-end system in accordance with an embodiment of this disclosure. The embodiment of the method 2100 shown in FIG. 21 is for illustration only, and other embodiments could be used without departing from the scope of this disclosure. For ease of explanation, the method 2100 is described as being performed by the processor 310.

In block 2110, the processor 310 identifies a zone blocked from a line of sight (LOS) of a base station, based on data measured over time by a user equipment (UE) located proximately to the zone. The data measured over time by the UE includes downlink signal quality measurements. The shadow zone (such as the coverage area 810) can be within the LoS of multiple base stations, but blocked from the LoS of one base station (such as gNB 840), as shown in FIG. 11B. The UE includes a UAV, such as the drone 522, that includes sensors configured to generate the data. The downlink signal quality measurements include reference signal measurements.

At block 2120, the processor 310 receives a three-dimensional (3D) spatial map of a first area including the zone and a second area that surrounds the zone and that is within both a coverage area and the LOS of the base station. As shown at block 2122, the first area includes the shadow zone and a second area. The second area surrounds the shadow zone, and the second area is within both a coverage area and a line of sight (LOS) of at least one base station.

At block 2130, the processor 310 determine whether the second area includes a mountable surface to which a passive radio frequency reflective metasurface is attachable. In response to a determination (in the affirmative) that the second area includes the mountable surface, the method 2100 proceeds to block 2150.

At block 2140, the processor 310 determines to not to add the metasurface to the second area, based on the determination (at block 2130) that the second area does not include the mountable surface.

In some embodiments, at blocks 2150-2160, the processor 310 determine whether to add a metasurface to the second area, based on: a determination result of whether the second area includes the mountable surface; and a determination result whether the reflection path from the metasurface attached to the mountable surface to the zone includes reflected downlink signals that satisfy a threshold bandwidth condition.

At block 2150, the processor 310 determines whether the metasurface, if attached to the mountable surface, generates a reflection path to the shadow zone. This determination can be based on the determination that the second area includes the mountable surface and based on estimated propagation paths from the base station to the zone. Examples of estimated propagation paths are shown in block 530 of FIG. 5 as the reflection paths 538 and/or a 3D density plot 539.

At block 2160, the processor 310 determines whether the reflection path from the metasurface attached to the mountable surface to the shadow zone includes reflected downlink signals that satisfy a threshold bandwidth condition. The method 2100 proceeds to block 2140, in response to a negative determination, which is a determination that the reflected downlink signals do not satisfy the threshold bandwidth condition. The method 2100 proceeds to block 2170, in response to an affirmative determination, which is a determination that the reflected downlink signals satisfy the threshold bandwidth condition.

In some embodiments of blocks 2150-2160, the processor 310 can determine whether to attach the metasurface to the mountable surface based on a determination that the reflection path from the metasurface attached to the mountable surface to the shadow zone includes reflected downlink signals that satisfy the threshold bandwidth condition.

In some embodiments of blocks 2150-2160, to determine whether to add a metasurface to the second area, the processor 310 performs the procedure of block 2140, namely making a determination to not to add the metasurface to the second area based on at least one of: a determination that the shadow zone is included within LOS of a second base station (such as gNB 1160); a determination (at block 2130) that the second area does not include the mountable surface; or a determination result (at block 2160) that the reflection path from the metasurface attached to the mountable surface to the zone includes reflected downlink signals that do not satisfy the threshold bandwidth condition. In some embodiments, the processor 310 determines whether to add a metasurface to the second area based on both: a determination result (at block 2130) of whether the second area includes the mountable surface; and a determination result (at block 2160) whether the reflection path from the metasurface attached to the mountable surface to the shadow zone includes reflected downlink signals that satisfy a threshold bandwidth condition.

At block 2170, the processor 310 determines to add and attach the metasurface to the mountable surface in the second area. The procedure of block 2170 can be the same as or similar to the procedure at block 1050 of FIG. 10, or block 1126 of FIG. 11A.

In some embodiments of blocks 2150-2160, to determine whether to add a metasurface to the second area, the processor 310 determines a variance over time for the determination result whether the reflection path from the metasurface attached to the mountable surface to the zone includes reflected downlink signals that satisfy a threshold bandwidth condition. The processor 310 determines to add the metasurface to the second area and to attach to the mountable surface, based on a determination that the variance over time fails to satisfy a time-varying condition.

At block 2180, the processor 310 designs the metasurface to be attached to the mountable surface. In some embodiments, to design the metasurface the processor 310 is further configured to: determine a magnitude and a phase response for unit cells of the metasurface, wherein at least some of the unit cells that have different configurations; determine far-field phase response based on a floquet mode analysis using an infinite uniform array; and determine a finite aperture using different combinations of the unit cells, thereby constructing single-beam apertures or multi-beam antenna apertures for a normal angle of incidence.

At block 2190, the processor 310 fabricates the designed metasurface. The procedure of block 2190 can be the same as or similar to the procedure at block 540 of FIG. 5 or block 650 of FIG. 6. To fabricating the designed metasurface, the processor 310 can perform any of the following functions: control an additive manufacturing device to generate an additively manufactured surface; generate a metal grated passive reflector by using printed circuit board (PCB) etching and milling techniques; deposit nanoparticle-based metal onto the additively manufactured surface by controlling a deposition device; or adhesively attaching a homogenous metal foil onto the additively manufactured surface by controlling actuators an automated manufacturing system.

Although FIG. 21 illustrates an example method 2100, various changes may be made to FIG. 21. For example, while shown as a series of steps, various steps in FIG. 21 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
identifying a zone blocked from a line of sight (LOS) of a base station, based on data measured over time by a user equipment (UE) located proximately to the zone, the data including downlink signal quality measurements;
receiving a three-dimensional (3D) spatial map of a first area including the zone and a second area that surrounds the zone and that is within both a coverage area and the LOS of the base station;
determining whether the second area includes a mountable surface to which a passive radio frequency reflective metasurface is attachable;
determining whether the metasurface, if attached to the mountable surface, generates a reflection path to the zone, based on a determination that the second area includes the mountable surface and based on estimated propagation paths from the base station to the zone;
determining whether to add a metasurface to the second area based on:
a determination result of whether the second area includes the mountable surface; and
a determination result whether the reflection path from the metasurface attached to the mountable surface to the zone includes reflected downlink signals that satisfy a threshold bandwidth condition.

2. The method of claim 1, wherein the UE includes an uncrewed aerial vehicle (UAV) that includes sensors configured to generate the data; and
wherein the downlink signal quality measurements include reference signal measurements.

3. The method of claim 1, wherein determining whether to add a metasurface to the second area further comprises:
determining a variance over time for the determination result whether the reflection path from the metasurface attached to the mountable surface to the zone includes reflected downlink signals that satisfy a threshold bandwidth condition; and
determining to add the metasurface to the second area and to attach to the mountable surface, based on a determination that the variance over time fails to satisfy a time-varying condition.

4. The method of claim 3, wherein determining whether to add a metasurface to the second area further comprises:
determining not to add the metasurface to the second area based on at least one of:
a determination that the second area does not include the mountable surface;
a determination result that the reflection path from the metasurface attached to the mountable surface to the zone includes reflected downlink signals that do not satisfy the threshold bandwidth condition; or
a determination that the zone is included within LOS of a second base station.

5. The method of claim 1, further comprising:
designing the metasurface to be attached to the mountable surface, wherein designing the metasurface comprises:
determining a magnitude and a phase response for unit cells of the metasurface, wherein at least some of the unit cells that have different configurations;
determining far-field phase response based on a floquet mode analysis using an infinite uniform array; and
determining a finite aperture using different combinations of the unit cells, thereby constructing single or multi-beam antenna apertures for a normal angle of incidence.

6. The method of claim 5, further comprising:
fabricating the designed metasurface by at least one of:
controlling an additive manufacturing device to generate an additively manufactured surface;
generating a metal grated passive reflector by using printed circuit board (PCB) etching and milling techniques;
depositing nanoparticle-based metal onto the additively manufactured surface; or
adhesively attaching a homogenous metal foil onto the additively manufactured surface.

7. The method of claim 1, further comprising designing the metasurface to be attached to the mountable surface, wherein:
the metasurface is composed from a plurality of unit cells;
designing the metasurface further comprises training a machine learning (ML) model to automatically generate unit cell placement values in response to receiving a query input;
the query input includes:
an angle of incidence,
beam directions,
quantity of unit cells of the metasurface, and
size of the unit cells; and
the unit cell placement values generated as output from the trained ML model includes at least one of:
a two-dimensional (2D) surface impedance excitation, or
at least one 2D image including a top view and a thickness of each finite surface of each of the unit cells.

8. An electronic device comprising:
a processor configured to:
identify a zone blocked from a line of sight (LOS) of a base station, based on data measured over time by a user equipment (UE) located proximately to the zone, the data including downlink signal quality measurements;
receive a three-dimensional (3D) spatial map of a first area including the zone and a second area that surrounds the zone and that is within both a coverage area and the LOS of the base station;
determine whether the second area includes a mountable surface to which a passive radio frequency reflective metasurface is attachable;
determine whether the metasurface, if attached to the mountable surface, generates a reflection path to the zone, based on a determination that the second area includes the mountable surface and based on estimated propagation paths from the base station to the zone;
determine whether to add a metasurface to the second area based on:
a determination result of whether the second area includes the mountable surface; and
a determination result whether the reflection path from the metasurface attached to the mountable surface to the zone includes reflected downlink signals that satisfy a threshold bandwidth condition.

9. The electronic device of claim 8, wherein the UE includes an uncrewed aerial vehicle (UAV) that includes sensors configured to generate the data; and
wherein the downlink signal quality measurements include reference signal measurements.

10. The electronic device of claim 8, wherein to determine whether to add a metasurface to the second area, the processor is further configured to:
determine a variance over time for the determination result whether the reflection path from the metasurface attached to the mountable surface to the zone includes reflected downlink signals that satisfy a threshold bandwidth condition; and
determine to add the metasurface to the second area and to attach to the mountable surface, based on a determination that the variance over time fails to satisfy a time-varying condition.

11. The electronic device of claim 10, wherein to determine whether to add a metasurface to the second area, the processor is further configured to:
determine not to add the metasurface to the second area based on at least one of:
a determination that the second area does not include the mountable surface;
a determination result that the reflection path from the metasurface attached to the mountable surface to the zone includes reflected downlink signals that do not satisfy the threshold bandwidth condition; or
a determination that the zone is included within LOS of a second base station.

12. The electronic device of claim 8, wherein the processor is further configured to:
design the metasurface to be attached to the mountable surface, wherein to design the metasurface the processor is further configured to:
determine a magnitude and a phase response for unit cells of the metasurface, wherein at least some of the unit cells that have different configurations;
determine far-field phase response based on a floquet mode analysis using an infinite uniform array; and
determine a finite aperture using different combinations of the unit cells, thereby constructing single or multi-beam antenna apertures for a normal angle of incidence.

13. The electronic device of claim 12, wherein the processor is further configured to:
fabricate the designed metasurface by at least one of:
controlling an additive manufacturing device to generate an additively manufactured surface;
generating a metal grated passive reflector by using printed circuit board (PCB) etching and milling techniques;
depositing nanoparticle-based metal onto the additively manufactured surface; or
adhesively attaching a homogenous metal foil onto the additively manufactured surface.

14. The electronic device of claim 8, wherein:
the processor is further configured to design the metasurface to be attached to the mountable surface, the metasurface composed from a plurality of unit cells;
to design the metasurface the processor is further configured to train a machine learning (ML) model to automatically generate unit cell placement values in response to receiving a query input;
the query input includes:
an angle of incidence,
beam directions,
quantity of unit cells of the metasurface, and
size of the unit cells; and
the unit cell placement values generated as output from the trained ML model includes at least one of:
a two-dimensional (2D) surface impedance excitation, or
at least one 2D image including a top view and a thickness of each finite surface of each of the unit cells.

15. A non-transitory computer readable medium embodying a computer program, the computer program comprising computer readable program code that when executed causes at least one processor to:
identify a zone blocked from a line of sight (LOS) of a base station, based on data measured over time by a user equipment (UE) located proximately to the zone, the data including downlink signal quality measurements;
receive a three-dimensional (3D) spatial map of a first area including the zone and a second area that surrounds the zone and that is within both a coverage area and the LOS of the base station;
determine whether the second area includes a mountable surface to which a passive radio frequency reflective metasurface is attachable;
determine whether the metasurface, if attached to the mountable surface, generates a reflection path to the zone, based on a determination that the second area includes the mountable surface and based on estimated propagation paths from the base station to the zone;
determine whether to add a metasurface to the second area based on:
a determination result of whether the second area includes the mountable surface; and
a determination result whether the reflection path from the metasurface attached to the mountable surface to the zone includes reflected downlink signals that satisfy a threshold bandwidth condition.

16. The non-transitory computer readable medium of claim 15, wherein the UE includes an uncrewed aerial vehicle (UAV) that includes sensors configured to generate the data; and
wherein the downlink signal quality measurements include reference signal measurements.

17. The non-transitory computer readable medium of claim 15, wherein the program code that when executed causes the at least one processor to determine whether to add a metasurface to the second area further comprises program code that when executed causes the at least one processor to:
determine a variance over time for the determination result whether the reflection path from the metasurface attached to the mountable surface to the zone includes reflected downlink signals that satisfy a threshold bandwidth condition; and
determine to add the metasurface to the second area and to attach to the mountable surface, based on a determination that the variance over time fails to satisfy a time-varying condition.

18. The non-transitory computer readable medium of claim 17, wherein the program code that when executed causes the at least one processor to determine whether to add a metasurface to the second area further comprises program code that when executed causes the at least one processor to:
determine not to add the metasurface to the second area based on at least one of:
a determination that the second area does not include the mountable surface;
a determination result that the reflection path from the metasurface attached to the mountable surface to the zone includes reflected downlink signals that do not satisfy the threshold bandwidth condition; or
a determination that the zone is included within LOS of a second base station.

19. The non-transitory computer readable medium of claim 15, further containing program code that when executed causes the at least one processor to:
design the metasurface to be attached to the mountable surface, wherein to design the metasurface the processor is further configured to:
determine a magnitude and a phase response for unit cells of the metasurface, wherein at least some of the unit cells that have different configurations;
determine far-field phase response based on a floquet mode analysis using an infinite uniform array; and
determine a finite aperture using different combinations of the unit cells, thereby constructing single or multi-beam antenna apertures for a normal angle of incidence.

20. The non-transitory computer readable medium of claim 15, further containing program code that when executed causes the at least one processor to:
design the metasurface to be attached to the mountable surface, the metasurface composed from a plurality of unit cells; and
train a machine learning (ML) model to automatically generate unit cell placement values in response to receiving a query input, wherein:
the query input includes:
an angle of incidence,
beam directions,
quantity of unit cells of the metasurface, and
size of the unit cells; and
the unit cell placement values generated as output from the trained ML model includes at least one of:
a two-dimensional (2D) surface impedance excitation, or
at least one 2D image including a top view and a thickness of each finite surface of each of the unit cells.
